(19) United States
(12) Patent Application Publication
(10) Pub. No.: US 2026/0273925 A1
(43) Pub. Date: Sep. 17, 2026

(54) LIQUID EJECTING HEAD AND LIQUID EJECTING APPARATUS

(71) Applicant: SEIKO EPSON CORPORATION, Tokyo (JP)

(72) Inventor: Kei YAMAGUCHI, SHIOJIRI-SHI (JP)

(21) Appl. No.: 19/567,628

(22) Filed: Mar. 16, 2026

(30) Foreign Application Priority Data
Mar. 17, 2025 (JP) 2025-042143

(51) Int. Cl. B41J 2/045; B41J 2/14

(52) U.S. Cl. CPC B41J 2/0451; B41J 2/04541; B41J 2/04581; B41J 2/14233; B41J 2002/14491

(57) ABSTRACT

A liquid ejecting head includes a piezoelectric substrate that includes a plurality of piezoelectric elements for ejecting a liquid, a wiring substrate, and a flexible substrate that electrically couples the piezoelectric substrate and the wiring substrate, in which the flexible substrate includes a base film that has a mounting surface, a plurality of wirings disposed on the mounting surface, an insulating cover film that covers the plurality of wirings so as to interpose the plurality of wirings between the cover film and the mounting surface, and a detection wiring disposed on the mounting surface at a position not covered with the cover film, and for detecting that the liquid is adhered to the detection wiring.

The present application is based on, and claims priority from JP Application Serial Number 2025-042143, filed Mar. 17, 2025, the disclosure of which is hereby incorporated by reference herein in its entirety.

### BACKGROUND

### 1. Technical Field

The present disclosure relates to a liquid ejecting head and a liquid ejecting apparatus.

### 2. Related Art

A liquid ejecting apparatus that prints an image by ejecting a liquid, such as ink, from a plurality of nozzles by using a piezoelectric element is known. For example, the liquid ejecting apparatus includes a liquid ejecting head having a plurality of drive elements for ejecting a liquid. For example, JP-A-2016-88084 discloses a liquid ejecting head including a flexible cable having a plurality of individual coupling wirings and a common coupling wiring for driving a plurality of piezoelectric elements. Hereinafter, the flexible cable may also be referred to as a flexible substrate.

Incidentally, the flexible substrate is provided with a plurality of wirings to which potentials different from each other are applied. In addition, an interval between the wirings of the flexible substrate is narrow. When moisture is adhered to the flexible substrate or the flexible substrate is exposed to a high-humidity environment, a phenomenon occurs in which the metal contained in the wiring on the flexible substrate becomes ionized and moves. This phenomenon is called ion migration or electrochemical migration. Hereinafter, ion migration, that is, electrochemical migration is also simply referred to as migration. When the migration occurs, there is a possibility that the individual coupling wirings or the individual coupling wiring and the common coupling wiring may be coupled to each other to be short-circuited. In addition, when the flexible substrate is exposed to a high-humidity environment, there is a possibility that the wiring may be disconnected due to electrolytic corrosion. Therefore, it is desirable to prevent the flexible substrate from failing when the liquid ejecting head is continuously used in a high-humidity environment by detecting that the flexible substrate is exposed to the high-humidity environment at an early stage.

### SUMMARY

According to an aspect of the present disclosure, there is provided a liquid ejecting head including an actuator substrate that includes a plurality of drive elements for ejecting a liquid, a wiring substrate, and a flexible substrate that electrically couples the actuator substrate and the wiring substrate, in which the flexible substrate includes a base film that has a mounting surface, a plurality of wirings disposed on the mounting surface, an insulating cover film that covers the plurality of wirings so as to interpose the plurality of wirings between the cover film and the mounting surface, and a detection wiring disposed on the mounting surface at a position not covered with the cover film, and for detecting that the liquid is adhered to the detection wiring.

In addition, according to another aspect of the present disclosure, there is provided a liquid ejecting apparatus including the liquid ejecting head described above, a detection circuit that outputs a detection signal for detecting a state of the detection wiring, a determination circuit that determines whether or not a liquid is in a state of being adhered to the detection wiring based on the detection signal, and a notification portion that notifies of an abnormality when the determination circuit determines that the liquid is in a state of being adhered to the detection wiring.

### BRIEF DESCRIPTION OF THE DRAWINGS

FIG. 1 is a schematic diagram illustrating a configuration of a liquid ejecting apparatus according to a first embodiment.

FIG. 2 is a diagram illustrating a functional configuration of the liquid ejecting apparatus illustrated in FIG. 1.

FIG. 3 is an exploded perspective view of a liquid ejecting head illustrated in FIG. 2.

FIG. 4 is an explanatory diagram illustrating a schematic structure of a liquid ejecting module illustrated in FIG. 3.

FIG. 5 is a cross-sectional view illustrating a piezoelectric substrate in FIG. 4.

FIG. 6 is a plan view illustrating the piezoelectric substrate in FIG. 4.

FIG. 7 is a diagram illustrating a flexible substrate illustrated in FIG. 4.

FIG. 8 is a cross-sectional view illustrating a part of the flexible substrate.

FIG. 9 is a diagram illustrating a flexible substrate according to a first modification example.

FIG. 10 is a diagram illustrating a flexible substrate according to a second modification example.

FIG. 11 is a diagram illustrating a flexible substrate according to another example of the second modification example.

FIG. 12 is a diagram illustrating a flexible substrate according to a third modification example.

FIG. 13 is a diagram illustrating a flexible substrate according to a fourth modification example.

FIG. 14 is a diagram illustrating a flexible substrate according to a fifth modification example.

### DESCRIPTION OF EMBODIMENTS

Hereinafter, an embodiment for performing the present disclosure will be described with reference to the drawings. However, in each drawing, the dimensions and scales of each part are appropriately different from those of the actual ones. In addition, since the embodiment described below is a suitable specific example of the present disclosure, various technically preferable limitations are added, and the scope of the present disclosure is not limited to these embodiments unless otherwise stated in the following description to particularly limit the present disclosure.

### 1. FIRST EMBODIMENT

### 1-1. Overall Configuration of Liquid Ejecting Apparatus 100

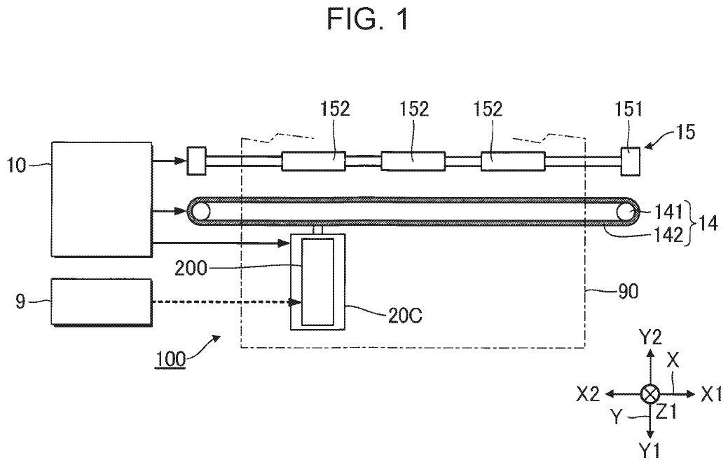

FIG. 1 is a schematic diagram illustrating a configuration of a liquid ejecting apparatus 100 according to a first embodiment. Hereinafter, for convenience of description, the description will be made by appropriately using an X axis, a Y axis, and a Z axis, which are orthogonal to one another. In addition, hereinafter, one direction along the X axis is referred to as an X1 direction, and a direction opposite to the X1 direction is referred to as an X2 direction. Similarly, one direction along the Y axis is referred to as a Y1 direction, and a direction opposite to the Y1 direction is referred to as a Y2 direction. One direction along the Z axis is referred to as a Z1 direction, and a direction opposite to the Z1 direction is referred to as a Z2 direction. In addition, viewing in the direction along the Z axis may be referred to as “plan view”. The Z axis is typically a vertical axis. The Z2 direction is an upper side, and the Z1 direction is a lower side. Hereinafter, the +Z direction may be referred to as the upward direction or the upper direction, and the −Z direction may be referred to as the downward direction or the lower direction. The direction along the Z axis corresponds to a gravity direction. The Z axis may not be the vertical axis. In addition, although the X axis, the Y axis, and the Z axis are typically orthogonal to one another, the axes are not limited thereto and may intersect at an angle within the range of, for example, 80 degrees or more and 100 degrees or less.

The liquid ejecting apparatus 100 in FIG. 1 is an ink jet type printing apparatus that ejects a liquid, such as ink, onto a medium 90. As illustrated in FIG. 1, in the present embodiment, it is assumed that the liquid ejecting apparatus 100 is a so-called serial printer as an example. The medium 90 is typically a printing paper, but a printing target of any material, such as a resin film or a cloth, is used as the medium 90. In addition, a liquid container 9 that stores the liquid is installed in the liquid ejecting apparatus 100. For example, a cartridge that can be attached to and detached from the liquid ejecting apparatus 100, a bag-shaped liquid pack made of a flexible film, or a liquid tank that can be replenished with a liquid is used as the liquid container 9.

The liquid ejecting apparatus 100 includes a control unit 10, a medium transport mechanism 15, a moving mechanism 14, and a liquid ejecting head 200.

For example, the control unit 10 includes one or a plurality of processing circuits, such as a central processing unit (CPU) or a field programmable gate array (FPGA), and one or a plurality of storage circuits, such as a semiconductor memory, and comprehensively controls each element of the liquid ejecting apparatus 100.

The medium transport mechanism 15 transports the medium 90 in a direction along the Y axis under the control of the control unit 10. For example, the medium transport mechanism 15 includes a transport motor 151 and a plurality of transport rollers 152. The transport motor 151 operates based on the control of the control unit 10. The plurality of transport rollers 152 rotate according to the operation of the transport motor 151. The medium 90 is transported in the direction along the Y axis, which is the transport direction, as the plurality of transport rollers 152 rotate.

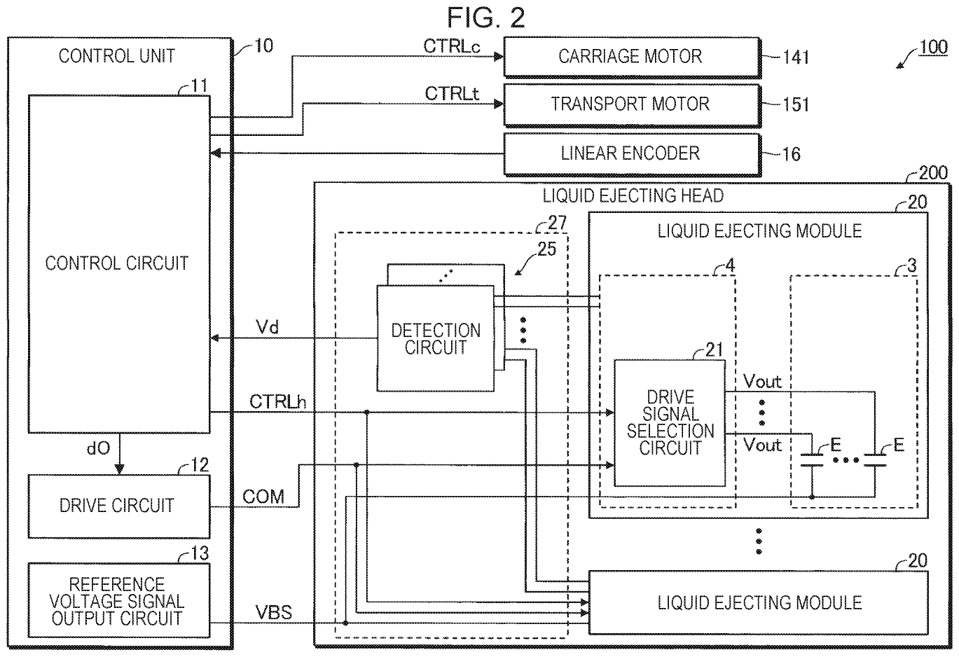

The moving mechanism 14 reciprocates a carriage 20C on which the liquid ejecting head 200 is mounted along the X axis under the control of the control unit 10. For example, the moving mechanism 14 includes a carriage motor 141 and an endless belt 142. The carriage motor 141 operates based on the control of the control unit 10. The endless belt 142 rotates according to the operation of the carriage motor 141. As a result, the carriage 20C fixed to the endless belt 142 reciprocates along the X axis which is the scanning axis. In addition, a linear encoder 16 illustrated in FIG. 2 (described later) is attached to the moving mechanism 14 in order to output a position detection signal based on the position of the carriage 20C.

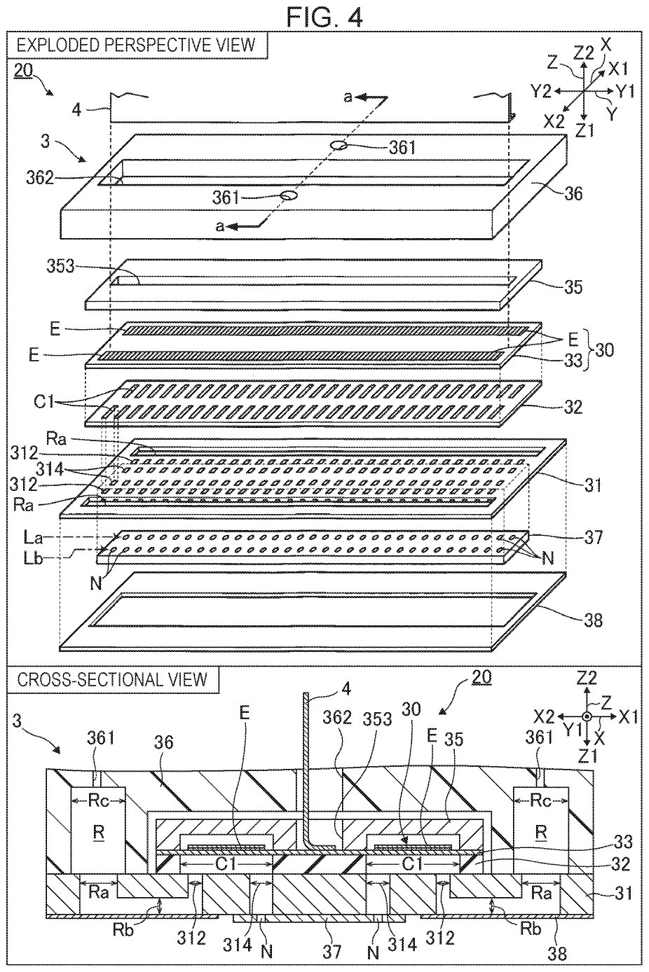

The liquid ejecting head 200 ejects the liquid supplied from the liquid container 9 to the medium 90 from a plurality of nozzles N illustrated in FIG. 4 described later, under the control of the control unit 10. An image is formed at the surface of the medium 90 by ejecting the liquid onto the medium 90 by each liquid ejecting head 200 in parallel with the transport of the medium 90 by the medium transport mechanism 15 and the reciprocating motion of the carriage 20C by the moving mechanism 14.

In FIG. 1, since it is assumed that the liquid ejecting apparatus 100 is a serial printer, a serial head method in which the liquid ejecting head 200 reciprocates on the medium 90 is adopted as a printing method. However, the printing method of the liquid ejecting apparatus 100 may be a line head method in which the liquid ejecting head 200 is fixed. That is, the liquid ejecting apparatus 100 may be a so-called line printer.

FIG. 2 is a diagram illustrating a functional configuration of the liquid ejecting apparatus 100 illustrated in FIG. 1.

The control unit 10 includes a control circuit 11, a drive circuit 12, and a reference voltage signal output circuit 13. An image information signal including image data or the like is input to the control circuit 11 from an external device, such as a host computer, that is coupled to the outside of the liquid ejecting apparatus 100 in a communicable manner. The control circuit 11 generates various signals for controlling the liquid ejecting apparatus 100 based on the image information signal, and outputs the various signals to the corresponding components.

In addition to the image information signal, a position detection signal based on the scanning position of the carriage 20C is input to the control circuit 11 from a linear encoder 16. The control circuit 11 grasps the scanning position of the liquid ejecting head 200 mounted on the carriage 20C based on the position detection signal. The control circuit 11 generates a control signal CTRLc for controlling the movement of the liquid ejecting head 200 according to the scanning position of the liquid ejecting head 200, and outputs the generated control signal CTRLc to the carriage motor 141. In addition, the control circuit 11 generates a control signal CTRLt for controlling the transport of the medium 90, and outputs the generated control signal CTRLt to the transport motor 151.

The control circuit 11 generates a control signal CTRLh for controlling the liquid ejecting head 200 based on the image information signal and the scanning position of the liquid ejecting head 200 described above, and outputs the generated control signal CTRLh. For example, the control signal CTRLh includes a print signal, a latch signal, a clock signal, and the like for designating the type of operation of the liquid ejecting head 200.

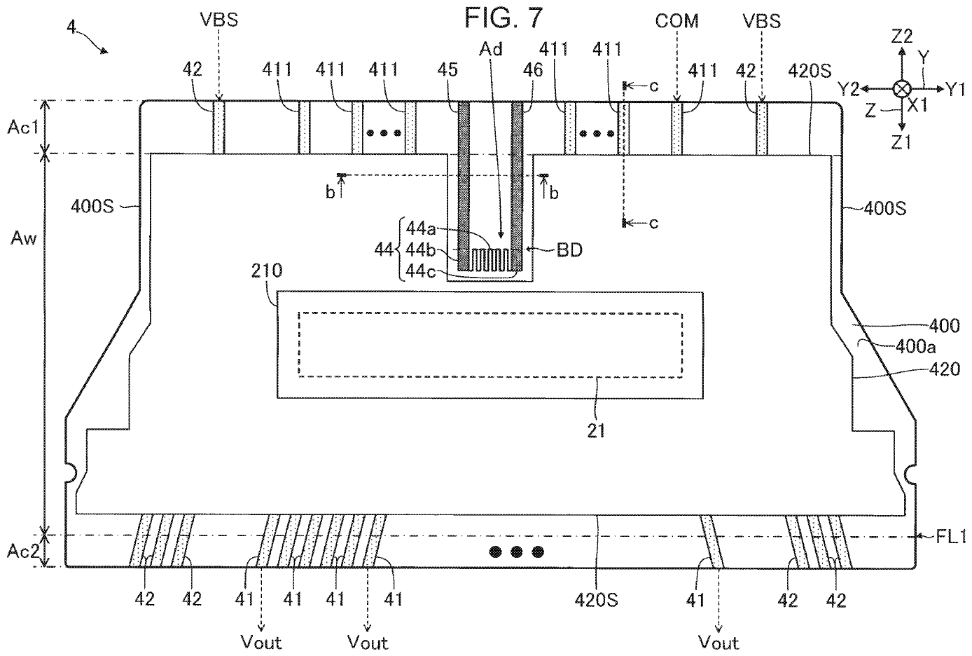

In addition, a detection signal Vd for detecting the state of a detection wiring 44 of a flexible substrate 4 illustrated in FIG. 7 and the like, which will be described later, is input to the control circuit 11 from the liquid ejecting head 200. For example, the state of the detection wiring 44 corresponds to whether or not a liquid, such as moisture, is adhered to the detection wiring 44. For example, the control circuit 11 determines whether or not the liquid is in a state of being adhered to the detection wiring 44 based on the detection signal Vd. The detection wiring 44 will be described later with reference to FIG. 7. The control circuit 11 is an example of a “determination circuit”.

In addition, the control circuit 11 outputs a base drive signal dO, which is a digital signal, to the drive circuit 12. The drive circuit 12 generates a drive signal COM by converting and amplifying the base drive signal dO into an analog signal, and outputs the generated drive signal COM to the liquid ejecting head 200.

The reference voltage signal output circuit 13 generates a reference voltage signal VBS and outputs the reference voltage signal VBS to the liquid ejecting head 200. The reference voltage signal VBS is a constant potential signal that is a reference for driving a piezoelectric element E described later provided in the liquid ejecting head 200. For example, the reference voltage signal VBS is a DC voltage signal having a constant potential.

The liquid ejecting head 200 includes a plurality of liquid ejecting modules 20 and a plurality of detection circuits 25 corresponding to the plurality of liquid ejecting modules 20. The plurality of liquid ejecting modules 20 all have a similar configuration. In addition, the plurality of detection circuits 25 all have a similar configuration. For example, the plurality of detection circuits 25 are mounted on a wiring substrate 27.

For example, each liquid ejecting module 20 includes a drive signal selection circuit 21 mounted on the flexible substrate 4 and a plurality of piezoelectric elements E included in a head chip 3. The control signal CTRLh, the drive signal COM, and the reference voltage signal VBS output from the control unit 10 are input to each liquid ejecting module 20 via the wiring substrate 27. Specifically, the control signal CTRLh and the drive signal COM are input to the drive signal selection circuit 21. The drive signal selection circuit 21 generates the drive signal Vout for each piezoelectric element E by selecting or not selecting the signal waveform of the drive signal COM based on the control signal CTRLh. The drive signal selection circuit 21 individually inputs each drive signal Vout to one end of the corresponding piezoelectric element E. In addition, the reference voltage signal VBS is commonly input to the other end of each of the plurality of piezoelectric elements E. Each of the plurality of piezoelectric elements E is driven by a potential difference between the supplied drive signal Vout and the reference voltage signal VBS. The amount of liquid corresponding to the driving of each of the plurality of piezoelectric elements E is ejected. As described above, the drive signal selection circuit 21 selects whether or not to supply the drive signal COM to each of the plurality of piezoelectric elements E. The drive signal selection circuit 21 is an example of a “selection circuit”, and the plurality of piezoelectric elements E are examples of “a plurality of drive elements”.

For example, the detection circuit 25 is electrically coupled to the detection wiring 44 via a first relay wiring 45 and a second relay wiring 46 provided on the flexible substrate 4 and illustrated in FIG. 7 to be described later. The detection circuit 25 outputs the detection signal Vd for detecting that the liquid is in a state of being adhered to the detection wiring 44. For example, the detection circuit 25 generates a detection signal Vd based on a change in the current flowing through the detection wiring 44 or a change in the voltage between one end and the other end of the detection wiring 44, and outputs the generated detection signal Vd to the control unit 10. A known circuit can be adopted as the detection circuit 25 that generates the detection signal Vd in response to the change in the current flowing through the detection wiring 44.

### 1-2. Liquid Ejecting Head 200

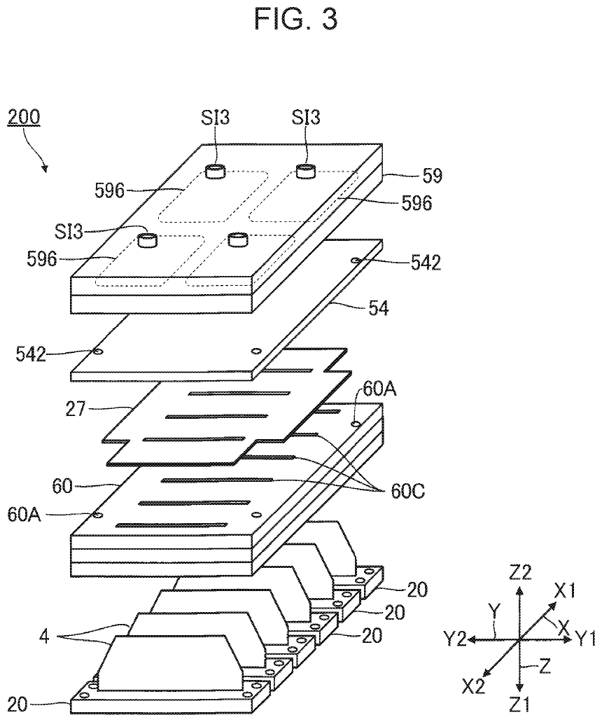

FIG. 3 is an exploded perspective view of the liquid ejecting head 200 illustrated in FIG. 2. The liquid ejecting head 200 illustrated in FIG. 3 includes a filter portion 59, a communication member 54, the wiring substrate 27, a liquid distribution portion 60, and the plurality of liquid ejecting modules 20. The liquid distribution portion 60 also functions as a holder that holds the plurality of liquid ejecting modules 20. The filter portion 59, the communication member 54, the wiring substrate 27, the liquid distribution portion 60, and the plurality of liquid ejecting modules 20 are arranged side by side in this order in the Z1 direction.

In the example illustrated in the drawing, the plurality of liquid ejecting modules 20 are six liquid ejecting modules 20. The plurality of liquid ejecting modules 20 are arranged in the direction along the X axis at intervals from each other. Each liquid ejecting module 20 includes the flexible substrate 4.

The filter portion 59 is an element that removes air bubbles and foreign substances contained in the liquid supplied from the liquid container 9. The filter portion 59 is a flat plate material made of a resin material. In addition, for example, four filters 596 are provided in the filter portion 59 according to the type of liquid. In addition, the filter portion 59 is provided with four supply ports SI3 for supplying the liquid from the liquid container 9 to the filter portion 59.

The communication member 54 is a flat plate material made of an elastic material. A plurality of through-holes 542 through which the liquid from the filter portion 59 flows are formed in the communication member 54.

The wiring substrate 27 is a substrate on which wiring for transmitting various signals, such as the drive signal COM, and a power supply voltage to each liquid ejecting module 20, is formed. The wiring substrate 27 is commonly provided for the plurality of liquid ejecting modules 20. For example, the detection circuit 25 illustrated in FIG. 2 is mounted on the wiring substrate 27. In addition, the wiring substrate 27 is formed with a coupling terminal (not illustrated) to which the flexible substrate 4 included in each liquid ejecting module 20 is electrically coupled, and the wiring substrate 27 and the flexible substrate 4 are electrically coupled.

The liquid distribution portion 60 is a member that distributes the liquid supplied through each through-hole 542 of the communication member 54 to each liquid ejecting module 20. The liquid distribution portion 60 includes a stack of a plurality of flat plate members. The liquid distribution portion 60 is made of a resin material. In addition, the liquid distribution portion 60 is provided with a through-hole 60C through which the flexible substrate 4 is inserted.

The liquid ejecting head 200 in FIG. 3 is an example, and any element may be further added to the liquid ejecting head 200 or may be omitted. For example, the liquid distribution portion 60 and the holder may be integrally configured. In addition, the disposition relationship of each element of the liquid ejecting head 200 is not limited to the example in FIG. 3. For example, the wiring substrate 27 may be located on the side of the plurality of liquid ejecting modules 20.

### 1-3. Liquid Ejecting Module 20

FIG. 4 is an explanatory diagram illustrating a schematic structure of the liquid ejecting module 20 illustrated in FIG. 3. An upper part in FIG. 4 is an exploded perspective view of the liquid ejecting module 20, and a lower part in FIG. 4 is a cross-sectional view taken along the line a-a illustrated in the exploded perspective view. The cross section taken along the line a-a is parallel to the XZ plane and passes through a supply port 361 described later. The liquid ejecting module 20 includes the head chip 3 and the flexible substrate 4. The Z axis is an axis along an ejection direction of the liquid by the liquid ejecting head 200.

As illustrated in the exploded perspective view in FIG. 4, the head chip 3 of the liquid ejecting module 20 includes a plurality of nozzles N arranged along the Y axis. The plurality of nozzles N are divided into a first nozzle row La and a second nozzle row Lb arranged in parallel at intervals from each other along the X axis. The second nozzle row Lb is arranged in parallel in the direction along the first nozzle row La. Each of the first nozzle row La and the second nozzle row Lb is a set of a plurality of nozzles N arranged linearly along the Y axis. The liquid ejecting module 20 has a structure in which an element related to each nozzle N of the first nozzle row La and an element related to each nozzle N of the second nozzle row Lb are disposed substantially in plane symmetry. In the following description, the elements corresponding to the first nozzle row La will be mainly described, and the description of the elements corresponding to the second nozzle row Lb will be omitted as appropriate.

As illustrated in FIG. 4, the head chip 3 includes a flow path forming substrate 31, a pressure chamber substrate 32, a vibration plate 33, a nozzle substrate 37, a vibration absorber 38, a plurality of piezoelectric elements E, a sealing body 35, and a flow path housing portion 36. Each of the flow path forming substrate 31, the pressure chamber substrate 32, the vibration plate 33, the nozzle substrate 37, the vibration absorber 38, the sealing body 35, and the flow path housing portion 36 is a long plate-shaped member along the Y axis. In addition, the nozzle substrate 37, the flow path forming substrate 31, the pressure chamber substrate 32, the vibration plate 33, and the sealing body 35 are arranged side by side in this order in the Z2 direction. In addition, the vibration plate 33 and the plurality of piezoelectric elements E constitute a piezoelectric substrate 30. The piezoelectric substrate 30 is an example of an “actuator substrate”.

The nozzle substrate 37 is a plate-shaped member in which the plurality of nozzles N are formed. The nozzle substrate 37 includes a first nozzle row La and a second nozzle row Lb. Each of the plurality of nozzles N is a circular through-hole for ejecting the liquid. For example, the nozzle substrate 37 is bonded to the surface of the flow path forming substrate 31 in the Z1 direction with an adhesive.

The flow path forming substrate 31 forms a flow path through which the liquid flows. Specifically, a space Ra, a relay liquid chamber Rb, a plurality of supply flow paths 312, and a plurality of communication flow paths 314 are formed in the flow path forming substrate 31. The space Ra is an opening formed in an elongated shape along the Y axis. Each of the supply flow path 312 and the communication flow path 314 is a through-hole formed for each nozzle N. Each of the communication flow paths 314 overlaps with the corresponding one nozzle N in a plan view when viewed from the Z1 direction. The relay liquid chamber Rb is an elongated space formed along the Y axis over the plurality of nozzles N, and allows the space Ra and the plurality of supply flow paths 312 to communicate with each other. In addition, the pressure chamber substrate 32 is bonded to the surface of the flow path forming substrate 31 in the Z2 direction with an adhesive.

The pressure chamber substrate 32 is coupled to the piezoelectric substrate 30. The pressure chamber substrate 32 is provided with a pressure chamber C1 whose volume changes in response to deformation of the piezoelectric substrate 30. The pressure chamber substrate 32 is also considered to partition the pressure chamber C1. The pressure chamber substrate 32 is made of silicon oxide. The liquid ejected from the nozzle N is stored in the pressure chamber C1. The pressure chamber C1 is a space located between the nozzle substrate 37 and the vibration plate 33 and formed by an inner wall surface of the pressure chamber substrate 32. The pressure chamber C1 is formed for each nozzle N. The pressure chamber C1 is an elongated space and extends in the X1 direction. The plurality of pressure chambers C1 are arranged side by side along the Y axis. Each pressure chamber C1 communicates with the communication flow path 314 and the supply flow path 312. Therefore, the pressure chamber C1 communicates with the nozzle N via the communication flow path 314 and communicates with the space Ra via the supply flow path 312 and the relay liquid chamber Rb.

The nozzle substrate 37, the flow path forming substrate 31, and the pressure chamber substrate 32 are manufactured by processing a single crystal substrate of silicon (Si) by using a semiconductor manufacturing technique, such as photolithography and etching. However, a known material or manufacturing method can be optionally adopted for manufacturing the nozzle substrate 37, the flow path forming substrate 31, and the pressure chamber substrate 32.

The vibration plate 33 of the piezoelectric substrate 30 is coupled to the surface of the pressure chamber substrate 32 opposite to the flow path forming substrate 31. The vibration plate 33 is disposed above the pressure chamber C1 and is elastically deformable. The vibration plate 33 vibrates by driving the piezoelectric element E. The vibration plate 33 is a plate-shaped member formed in a long rectangular shape along the Y axis in a plan view. The vibration plate 33 and the pressure chamber C1 may be integrally configured or may be separately configured and bonded with an adhesive or the like.

The piezoelectric element E is formed above the surface of the vibration plate 33 opposite to the pressure chamber C1. The piezoelectric element E is provided for each pressure chamber C1. The piezoelectric element E has an elongated shape along the X axis in a plan view. The piezoelectric element E is a drive element that is driven by the application of the drive signal Vout, and applies pressure to the liquid in the pressure chamber C1.

For example, the sealing body 35 is bonded to the vibration plate 33 with an adhesive. The sealing body 35 is a structure that protects the plurality of piezoelectric elements E and reinforces the mechanical strength of the pressure chamber substrate 32 and the vibration plate 33. A recess on the surface facing the vibration plate 33 is formed in the sealing body 35. The plurality of piezoelectric elements E are accommodated inside the recess. In addition, the sealing body 35 has a space 353 through which the flexible substrate 4 is inserted.

In addition, the vibration absorber 38 is bonded to the surface of the flow path forming substrate 31 in the Z1 direction with, for example, an adhesive. The vibration absorber 38 is a flexible film that forms a wall surface of the space Ra.

For example, the flow path housing portion 36 is bonded to the flow path forming substrate 31 with an adhesive. The flow path housing portion 36 is a case for storing the liquid supplied to the plurality of pressure chambers C1. For example, the flow path housing portion 36 is formed by injection molding of a resin material. A space Rc, a supply port 361, and a space 362 are formed in the flow path housing portion 36. The supply port 361 is a pipeline through which the liquid is supplied from the liquid container 9 via the liquid distribution portion 60, and communicates with the space Rc. The space Rc communicates with the space Ra of the flow path forming substrate 31. The space including the space Rc and the space Ra functions as a liquid storage chamber R that stores the liquid supplied to the plurality of pressure chambers C1. The liquid supplied from the liquid container 9 and passing through the supply port 361 is stored in the liquid storage chamber R. The liquid stored in the liquid storage chamber R is branched from the relay liquid chamber Rb to the supply flow paths 312 and is supplied in parallel to the plurality of pressure chambers C1. In addition, the space 362 overlaps the space 353 of the sealing body 35 in a plan view. The flexible substrate 4 is inserted into the space 353 and the space 362.

The flexible substrate 4 is coupled to the vibration plate 33. The flexible substrate 4 electrically couples the piezoelectric substrate 30 and the wiring substrate 27. The flexible substrate 4 is a mounted component in which a plurality of wirings are formed. For example, the flexible substrate 4 is a flexible circuit substrate, such as a flexible printed circuit (FPC) or a chip on film (COF). The drive signal selection circuit 21 in FIG. 2 is mounted on the flexible substrate 4.

In the liquid ejecting module 20 illustrated in FIG. 4, when the piezoelectric element E is bent and deformed by applying a voltage, the vibration plate 33 is bent and deformed in a direction in which the volume of the pressure chamber C1 is reduced. That is, when the piezoelectric element E is bent and deformed by applying a voltage, the vibration plate 33 vibrates. As a result, the pressure of the pressure chamber C1 changes, and the liquid in the pressure chamber C1 is ejected from the nozzle N. The piezoelectric element E is restored to the original position after the liquid is ejected.

The configuration of the liquid ejecting module 20 is not limited to the example illustrated in FIG. 4. For example, the liquid ejecting module 20 may not have a part of a plurality of elements illustrated in FIG. 4, or may have other elements instead of a part of the plurality of elements illustrated in FIG. 4. Alternatively, the liquid ejecting module 20 may have other elements in addition to the plurality of elements illustrated in FIG. 4.

### 1-4. Piezoelectric Substrate 30

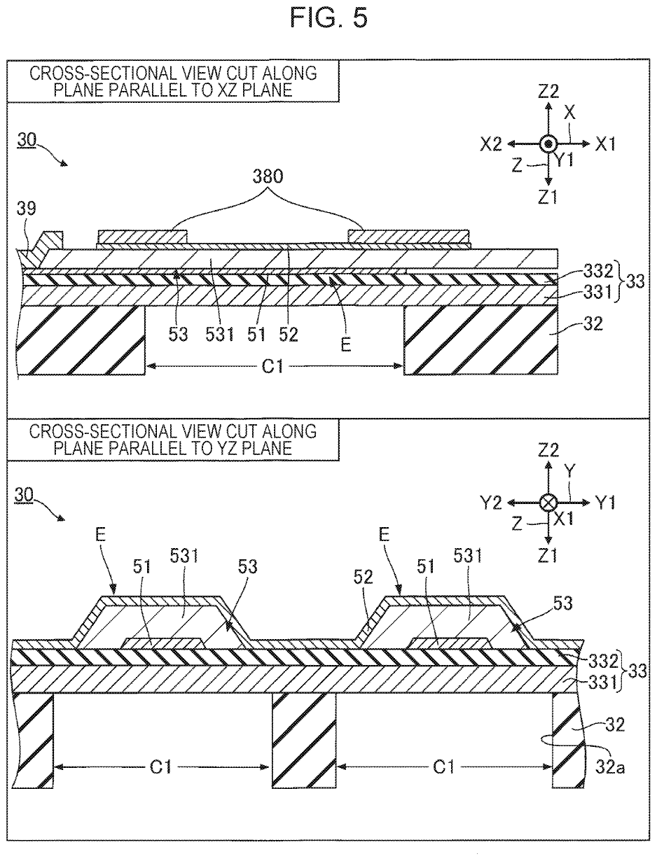

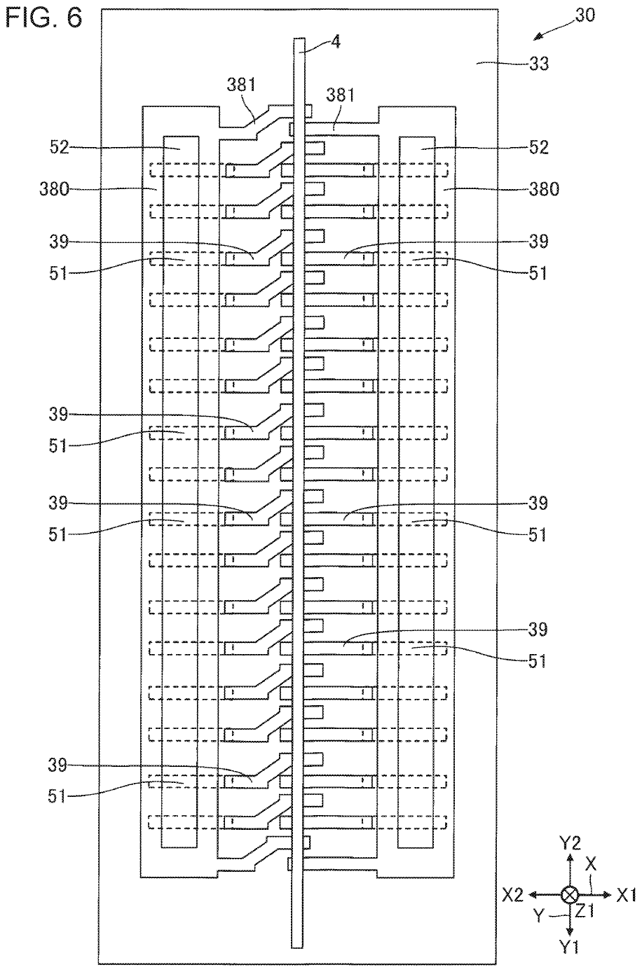

FIG. 5 is a cross-sectional view illustrating the piezoelectric substrate 30 in FIG. 4. In addition, FIG. 6 is a plan view illustrating the piezoelectric substrate 30 in FIG. 4.

An upper part in FIG. 5 is a cross-sectional view of the piezoelectric substrate 30 when the piezoelectric substrate 30 is cut along a plane parallel to the XZ plane so as to include the piezoelectric element E. In addition, a lower part in FIG. 5 is a cross-sectional view of the piezoelectric substrate 30 when the piezoelectric substrate 30 is cut along a plane parallel to the YZ plane so as to include the piezoelectric element E. In FIG. 5, the pressure chamber substrate 32 is also illustrated in order to facilitate understanding of the piezoelectric substrate 30.

As illustrated in FIG. 5, for example, the vibration plate 33 of the piezoelectric substrate 30 includes a stack including a first layer 331 and a second layer 332. The first layer 331 is in contact with the pressure chamber substrate 32. The second layer 332 is disposed above the first layer 331. The second layer 332 is located at a position closer to the piezoelectric element E than the first layer 331. The second layer 332 is made of an insulating material, such as zirconium oxide (ZrOₓ). For example, the first layer 331 is formed by thermally oxidizing a part of the pressure chamber substrate 32. For example, the second layer 332 is formed by a known film forming technique, such as sputtering. The vibration plate 33 may include one layer or may include three or more layers.

The piezoelectric element E mainly includes an individual electrode 51, a piezoelectric layer 53, and a common electrode 52. The individual electrode 51, the piezoelectric layer 53, and the common electrode 52 are stacked in a direction along the Z axis, which is the stacking direction. In addition, the piezoelectric layer 53 includes a plurality of piezoelectric portions 531. In FIG. 6, the piezoelectric layer 53 is not illustrated.

The individual electrode 51 is provided above the vibration plate 33. The individual electrode 51 is an individual electrode provided for each piezoelectric element E. The drive signal Vout is applied to the individual electrode 51. The individual electrode 51 has an elongated shape along the X axis. A plurality of individual electrodes 51 are arranged along the Y axis at intervals from each other. The individual electrode 51 contains a conductive material, such as metal.

The piezoelectric layer 53 is provided above the individual electrode 51. For example, the piezoelectric layer 53 is a strip-shaped dielectric film that is continuous over the plurality of piezoelectric elements E along the Y axis. For example, the piezoelectric layer 53 has a strip shape extending along the Y axis and is separated for each piezoelectric element E by forming a plurality of notches. Since the plurality of notches are formed, the piezoelectric layer 53 includes a plurality of piezoelectric portions 531. The plurality of individual electrodes 51 described above are provided to correspond to the plurality of piezoelectric portions 531. In addition, for example, the piezoelectric layer 53 is made of a piezoelectric material having a perovskite crystal structure.

Examples of the piezoelectric material include lead titanate (PbTiO₃), lead zirconate titanate (PZT: Pb(Zr, Ti)O₃), lead zirconate (PbZrO₃), lead lanthanum titanate ((Pb, La), TiO₃), lead lanthanum titanate zirconate ((Pb, La)(Zr, Ti)O₃), lead zirconate niobate titanate (Pb(Zr, Ti, Nb)O₃), and lead magnesium niobate zirconate titanate (Pb(Zr, Ti)(Mg, Nb)O₃). Among these, lead zirconate titanate (PZT) is suitably used as a constituent material of the piezoelectric layer 53.

The common electrode 52 is provided above the piezoelectric layer 53. The common electrode 52 is a strip-shaped common electrode extending along the Y axis to be continuous over the plurality of piezoelectric elements E. The common electrode 52 is shared by the plurality of piezoelectric portions 531 described above. The reference voltage signal VBS is applied to the common electrode 52. The common electrode 52 contains a conductive material, such as metal.

A voltage corresponding to a difference between the reference voltage signal VBS applied to the common electrode 52 and the drive signal Vout corresponding to the ejection amount supplied to the individual electrode 51 is applied to the piezoelectric portion 531. The piezoelectric portion 531 is deformed by applying a voltage between the individual electrode 51 and the common electrode 52, and the piezoelectric element E is bent and deformed, that is, vibrates by the deformation of the piezoelectric portion 531.

In addition, a weight portion 380 is provided in contact with the common electrode 52 above the common electrode 52.

As illustrated in FIG. 6, the weight portion 380 has a quadrangular frame shape. The weight portion 380 functions as a weight for preventing excessive vibration of the vibration plate 33. In addition, a coupling electrode 381 is coupled to the weight portion 380. The coupling electrode 381 is coupled to the flexible substrate 4. The reference voltage signal VBS is applied to the common electrode 52 described above via the coupling electrode 381 and the weight portion 380. For example, the weight portion 380 contains a metal, such as gold.

In addition, as illustrated in FIGS. 5 and 6, a coupling electrode 39 is coupled to each of the individual electrodes 51 described above. The coupling electrode 39 is coupled to the flexible substrate 4. The drive signal Vout is applied to the individual electrode 51 described above via the coupling electrode 39. For example, the coupling electrode 39 contains a metal, such as gold.

In the examples illustrated in FIG. 5, the individual electrode 51 is provided below the piezoelectric layer 53, and the common electrode 52 is provided above the piezoelectric layer 53. However, the common electrode 52 may be provided below the piezoelectric layer 53, and the individual electrode 51 may be provided above the piezoelectric layer 53.

### 1-5. Flexible Substrate 4

FIG. 7 is a diagram illustrating the flexible substrate 4 illustrated in FIG. 4. In FIG. 7, a plan view of the flexible substrate 4 is schematically illustrated. In addition, in FIG. 7, an identification mark for identifying the flexible substrate 4, an alignment mark used for positioning the flexible substrate 4 and other members, and the like are not illustrated. The identification mark and the alignment mark may be appropriately omitted.

For example, the flexible substrate 4 includes a first coupling region Ac1 coupled to the wiring substrate 27 at the end portion in the Z2 direction and a second coupling region Ac2 coupled to the piezoelectric substrate 30 at the end portion in the Z1 direction. The flexible substrate 4 includes a wiring region Aw between the first coupling region Ac1 and the second coupling region Ac2. As illustrated in the cross-sectional view in FIG. 4, the flexible substrate 4 is bent by substantially 90 degrees at a bent portion FL1 of a boundary portion between the second coupling region Ac2 and the wiring region Aw. In FIG. 7, the flexible substrate 4 in a state of not being bent is illustrated.

As described above, the second coupling region Ac2 is a portion coupled to the piezoelectric substrate 30 and is a portion that extends on the XY plane bent with respect to the wiring region Aw. The wiring region Aw is a portion not directly coupled to the piezoelectric substrate 30. The wiring region Aw is a portion that extends on the YZ plane, and is a portion that extends from the piezoelectric substrate 30 in the Z2 direction. That is, the wiring region Aw extends in the gravity direction. A mounted component 210, which is an integrated circuit, is provided in the wiring region Aw. For example, the drive signal selection circuit 21 in FIG. 2 is mounted on the mounted component 210. The mounted component 210 is an example of a “drive component”. In addition, most of the wiring region Aw is covered with a cover film 420 of the insulator made of a resin, such as polyimide.

For example, the flexible substrate 4 includes a base film 400, a cover film 420, a plurality of electric wirings 411, a plurality of drive signal wirings 41, a plurality of constant voltage wirings 42, a detection wiring 44, a first relay wiring 45, a second relay wiring 46, and a mounted component 210. The flexible substrate 4 may not have the mounted component 210. In this case, the drive signal selection circuit 21 is provided on the wiring substrate 27 or another substrate coupled to the first coupling region Ac1 of the flexible substrate 4. When the flexible substrate 4 does not have the drive signal selection circuit 21, for example, each of one end and the other end of each of the plurality of drive signal wirings 41 is disposed in the first coupling region Ac1 and the second coupling region Ac2.

The base film 400 is an insulator made of a resin, such as polyimide. The base film 400 is a flexible film-like member and has the mounting surface 400a. The plurality of electric wirings 411, the plurality of drive signal wirings 41, the plurality of constant voltage wirings 42, the detection wiring 44, the first relay wiring 45, and the second relay wiring 46 are formed at the mounting surface 400a of the base film 400. Among these wirings, the wirings excluding the detection wiring 44, the first relay wiring 45, and the second relay wiring 46 are covered with the cover film 420 in most of the region of the wiring region Aw. A part of each of the first relay wiring 45 and the second relay wiring 46 may be covered with the cover film 420.

The cover film 420 is a flexible film-like member and is an insulator made of a resin, such as polyimide. The cover film 420 covers the plurality of electric wirings 411, the plurality of drive signal wirings 41, and the plurality of constant voltage wirings 42 so as to interpose these wirings between the cover film 420 and the mounting surface 400a of the base film 400. The plurality of electric wirings 411, the plurality of drive signal wirings 41, and the plurality of constant voltage wirings 42 are examples of the “plurality of wirings”.

The direction in which the plurality of electric wirings 411, the plurality of drive signal wirings 41, the plurality of constant voltage wirings 42, the first relay wiring 45, and the second relay wiring 46 are respectively disposed is substantially the same direction, and is substantially a direction along the Z axis.

The plurality of electric wirings 411 are located in the Z2 direction with respect to the plurality of drive signal wirings 41. For example, the plurality of electric wirings 411 are located at a center portion of the base film 400 along the Y axis. The plurality of electric wirings 411 are arranged side by side along the Y axis at intervals from each other. In addition, for example, the plurality of electric wirings 411 are input-side wirings for inputting input signals, such as the drive signal COM, the latch signal, and the clock signal, to the mounted component 210, and are coupled to the wiring substrate 27 and the mounted component 210. The plurality of electric wirings 411 may include wirings used as the power supply voltage or the like for the various components of the mounted component 210 or the liquid ejecting module 20. In addition, the electric wiring 411 to which the drive signal COM is supplied is not limited to the example illustrated in FIG. 7.

The plurality of drive signal wirings 41 are located in the Z1 direction in the base film 400 and are provided at the center portion of the base film 400 along the Y axis. The plurality of drive signal wirings 41 are arranged side by side along the Y axis at intervals from each other. The plurality of drive signal wirings 41 are output-side wirings that transmit the drive signal Vout to the plurality of piezoelectric elements E, are wired from the mounted component 210 to the second coupling region Ac2, and are coupled to the mounted component 210 and the piezoelectric substrate 30. The plurality of drive signal wirings 41 correspond to the plurality of individual electrodes 51 on a one-to-one basis.

The plurality of constant voltage wirings 42 are located outside the base film 400 with respect to the plurality of drive signal wirings 41 along the Y axis, and are disposed to interpose a group of the plurality of drive signal wirings 41 along the Y axis. In addition, the plurality of constant voltage wirings 42 are disposed to interpose a group of the plurality of electric wirings 411 in the Y axis direction. The constant voltage wiring 42 is not coupled to the mounted component 210, and is disposed from the first coupling region Ac1 on the input side located in the Z2 direction of the flexible substrate 4 to the second coupling region Ac2 on the output side located in the Z1 direction. That is, one end and the other end of the constant voltage wiring 42 are disposed in each of the first coupling region Ac1 and the second coupling region Ac2. The constant voltage wiring 42 is one wiring in the first coupling region Ac1 and is divided into a plurality of wirings in the second coupling region Ac2. In the example illustrated in FIG. 7, the constant voltage wiring 42 is one wiring in the first coupling region Ac1, and is divided into three wirings in the second coupling region Ac2. The plurality of constant voltage wirings 42 in the second coupling region Ac2 are arranged side by side along the Y axis at intervals from each other.

Since the constant voltage wiring 42 is divided into the plurality of wirings in the second coupling region Ac2, the surface area to which the adhesive is adhered can be increased when a plurality of wirings are coupled. As a result, the flexible substrate 4 is unlikely to be peeled off from the piezoelectric substrate 30, and it is possible to prevent the disconnection of the constant voltage wiring 42. In addition, since the constant voltage wiring 42 is divided into the plurality of wirings in the second coupling region Ac2, it is possible to prevent the occurrence of a contact failure even when the positional displacement occurs when the constant voltage wiring 42 is coupled to the coupling electrode 381 of the piezoelectric substrate 30 in the second coupling region Ac2.

The number of the constant voltage wirings 42 in the second coupling region Ac2 is not limited to three, and may be one or two. Alternatively, the number of constant voltage wirings 42 in the second coupling region Ac2 may be four or more. In addition, the constant voltage wiring 42 may also be divided into a plurality of wirings in the first coupling region Ac1 on the input side located in the Z2 direction.

The constant voltage wiring 42 is held at a constant voltage. The reference voltage signal VBS is applied to the constant voltage wiring 42. The potential of the reference voltage signal VBS may be a ground potential or a potential different from the ground potential. The plurality of constant voltage wirings 42 are electrically coupled to the common electrode 52.

In the example illustrated in FIG. 7, the flexible substrate 4 does not have other wirings between an end side 400S of the flexible substrate 4 in the Y1 direction and the constant voltage wiring 42 in the direction along the Y axis. Similarly, the flexible substrate 4 does not have other wirings between the end side 400S of the flexible substrate 4 in the Y2 direction and the constant voltage wiring 42 in the direction along the Y axis. That is, the constant voltage wiring 42 is provided on the outermost side of the flexible substrate 4 along the Y axis. The end side 400S is a side extending along the YZ plane in a direction intersecting the extending direction of the first nozzle row La. By providing the constant voltage wiring 42 on the outermost side of the flexible substrate 4, it is possible to suppress the noise from the other wirings from being superimposed on the constant voltage wiring 42.

The detection wiring 44 is a wiring for detecting that a liquid, such as moisture, is adhered to the detection wiring 44. In the present embodiment, a state where a liquid, such as moisture, is adhered to the flexible substrate 4 is also regarded as a state where the flexible substrate 4 is exposed to a high-humidity environment. Therefore, the detection wiring 44 can also be regarded as wiring for detecting that the flexible substrate 4 is exposed to a high-humidity environment. For example, when a voltage is applied to the wiring on the flexible substrate 4 in a state where the flexible substrate 4 is exposed to a high-humidity environment, a phenomenon occurs in which the metal included in the anode wiring is ionized and moves to the cathode wiring. This phenomenon is called ion migration or electrochemical migration. Hereinafter, ion migration, that is, electrochemical migration is also simply referred to as migration.

For example, the detection wiring 44 is disposed on the mounting surface 400a of the base film 400 at a position not covered with the cover film 420. Specifically, the detection wiring 44 is disposed in the detection region Ad not covered with the cover film 420 in the wiring region Aw. In the example illustrated in FIG. 7, the detection region Ad is a region partitioned by a notch formed at the end portion of the cover film 420 in the Z2 direction, and is located between the first coupling region Ac1 and the mounted component 210. That is, the detection wiring 44 is disposed between the first coupling region Ac1 and the mounted component 210. As described above, the detection wiring 44 is disposed between an end side 420S of the cover film 420 in the Z1 direction and an end side 420S of the cover film 420 in the Z2 direction. That is, the detection wiring 44 is disposed between one end and the other end of the cover film 420 in the direction from the second coupling region Ac2 to the first coupling region Ac1. In the present embodiment, the detection wiring 44 is disposed closer to the mounted component 210 than the first coupling region Ac1. In addition, in the example illustrated in FIG. 7, the detection wiring 44 is provided at the center portion of the base film 400 along the Y axis.

The detection wiring 44 includes a resistance wiring portion 44a disposed in a serpentine shape so as to reciprocate a plurality of times along the Z axis, a first wiring portion 44b that couples one end of the resistance wiring portion 44a and the first relay wiring 45, and a second wiring portion 44c that couples the other end of the resistance wiring portion 44a and the second relay wiring 46.

For example, when the liquid is adhered to the resistance wiring portion 44a of the detection wiring 44, a current also flows through the liquid. Therefore, the electric resistance between the first relay wiring 45 and the second relay wiring 46 is different between the state where the liquid is adhered to the resistance wiring portion 44a and the state where the liquid does not adhere to the resistance wiring portion 44a. That is, when the liquid is adhered to the resistance wiring portion 44a, the electric resistance between the first relay wiring 45 and the second relay wiring 46 changes. The current flowing through the first relay wiring 45 or the second relay wiring 46, or the voltage between the first relay wiring 45 and the second relay wiring 46, changes in accordance with the change in the electric resistance between the first relay wiring 45 and the second relay wiring 46. For example, the detection circuit 25 outputs the detection signal Vd according to the change in the current flowing through the first relay wiring 45 or the second relay wiring 46, or the change in the voltage between the first relay wiring 45 and the second relay wiring 46, to the control unit 10. The change in the current flowing through the first relay wiring 45 or the second relay wiring 46 corresponds to the change in the current flowing through the detection wiring 44, and the change in the voltage between the first relay wiring 45 and the second relay wiring 46 corresponds to the voltage between one end and the other end of the detection wiring 44.

As described above, the detection signal Vd indicates a change in the electric resistance between the first relay wiring 45 and the second relay wiring 46 due to the liquid being adhered to the resistance wiring portion 44a. Therefore, the control circuit 11 of the control unit 10 can determine whether or not the liquid is in a state of being adhered to the detection wiring 44 based on the detection signal Vd. In addition, even when the liquid is adhered across the first relay wiring 45 and the second relay wiring 46, the electric resistance between the first relay wiring 45 and the second relay wiring 46 changes. Therefore, even when the liquid is adhered across the first relay wiring 45 and the second relay wiring 46, the control circuit 11 can detect that the flexible substrate 4 is exposed to a high-humidity environment based on the detection signal Vd.

In the present embodiment, since the resistance wiring portion 44a is formed in a serpentine shape, the wiring length of the resistance wiring portion 44a can be made longer than the interval between the first relay wiring 45 and the second relay wiring 46, and the resistance of the resistance wiring portion 44a can be increased. Therefore, in the present embodiment, it is possible to easily detect the change in the electric resistance between the two points of the resistance wiring portion 44a due to a small amount of liquid being adhered to the resistance wiring portion 44a.

Each of the first relay wiring 45 and the second relay wiring 46 is wired from the first coupling region Ac1 to the detection wiring 44. Therefore, each of the end portions of the first relay wiring 45 and the second relay wiring 46 in the Z2 direction is located in the first coupling region Ac1, and each of the end portions of the first relay wiring 45 and the second relay wiring 46 in the Z1 direction is coupled to the detection wiring 44. A boundary BD illustrated in FIG. 7 indicates the boundary between the first relay wiring 45 and the first wiring portion 44b of the detection wiring 44, and the boundary between the second relay wiring 46 and the second wiring portion 44c of the detection wiring 44. For example, the boundary BD corresponds to an end portion of the resistance wiring portion 44a in the Z2 direction. However, the boundary between the first relay wiring 45 and the first wiring portion 44b of the detection wiring 44, and the boundary between the second relay wiring 46 and the second wiring portion 44c of the detection wiring 44 are not limited to the example illustrated in FIG. 7. In addition, for example, one of the first relay wiring 45 and the second relay wiring 46 may be electrically coupled to the detection circuit 25, and the other of the first relay wiring 45 and the second relay wiring 46 may be electrically coupled to a constant voltage source or a constant current source.

The material of each of the plurality of drive signal wirings 41, the plurality of constant voltage wirings 42, the detection wiring 44, the first relay wiring 45, the second relay wiring 46, and the plurality of electric wirings 411 is not particularly limited as long as the material is a material having conductivity, and includes, for example, metals such as gold (Au), copper (Cu), titanium (Ti), tungsten (W), nickel (Ni), chromium (Cr), platinum (Pt), aluminum (Al), and tin (Sn).

Here, when the flexible substrate 4 is exposed to a high-humidity environment, there is a possibility that failures, such as disconnection of the wiring due to electrolytic corrosion and short-circuiting between the wirings due to migration, may occur.

For example, in a case in which a UV ink containing a monomer or the like that is cured by ultraviolet irradiation is used, when the monomer contained in the UV ink permeates the adhesive that couples the flow path, the space accommodating the flexible substrate 4 becomes high humidity. In this case, among the wirings of the flexible substrate 4, since a portion exposed to the space accommodating the flexible substrate 4 is exposed to high humidity air, there is a possibility that migration occurs in the wiring of the portion exposed to the space accommodating the flexible substrate 4 and the wirings are short-circuited. That is, there is a possibility that migration occurs in a portion not covered with the cover film 420 of the plurality of wirings provided on the flexible substrate 4 and the wirings are short-circuited. For example, the wirings in the first coupling region Ac1 and the second coupling region Ac2 correspond to the wirings in the portion not covered with the cover film 420. Therefore, the wirings in the first coupling region Ac1 and the second coupling region Ac2 are likely to cause short-circuiting due to migration. In particular, since the interval between the wirings in the second coupling region Ac2 is narrow, short-circuiting due to migration is likely to occur. When the drive signal wirings 41 are short-circuited, the drive signal Vout cannot be appropriately transmitted to the piezoelectric element E, and a liquid ejection failure or a serious error occurs.

In the present embodiment, as described above, since the detection wiring 44 exposed to the space accommodating the flexible substrate 4 is provided, it can be detected that the space is a high-humidity environment by detecting the state of the detection wiring 44. As a result, in the present embodiment, for example, it is possible to detect the abnormality of the liquid ejecting head 200 that the unintended wet air enters. In addition, in the present embodiment, for example, when it is detected that the liquid is in a state of being adhered to the detection wiring 44, it is possible to improve the environment in which migration and electrolytic corrosion are likely to occur by promoting ventilation in the liquid ejecting head 200 or the liquid ejecting apparatus 100. As a result, in the present embodiment, it is possible to prevent the flexible substrate 4 from failing when the liquid ejecting head 200 is continuously used in a high-humidity environment. For example, when it is determined that the liquid is in a state of being adhered to the detection wiring 44, the control circuit 11 may display a message indicating that the usage environment of the liquid ejecting head 200 is a high-humidity environment, a message prompting ventilation in the liquid ejecting head 200 or the liquid ejecting apparatus 100, or the like on a display portion such as a liquid crystal display or an organic EL display (not illustrated) of the liquid ejecting apparatus 100. That is, the control circuit 11 may function as a notification portion that notifies of an abnormality when it is determined that the liquid is in a state of being adhered to the detection wiring 44. Alternatively, the liquid ejecting apparatus 100 may include a notification portion that notifies of an abnormality when the control circuit 11 determines that the liquid is in a state of being adhered to the detection wiring 44. Instead of the display portion or the notification portion, for example, the notification may be made by a sound generation portion that generates a warning sound or voice, or the notification may be made by blinking or turning on a white light portion such as an LED lamp. In addition, a message for promoting ventilation or a signal for notifying an abnormality may be output to an external device such as a host computer that is communicably coupled to the outside of the liquid ejecting apparatus 100.

In addition, in the example illustrated in FIG. 7, since the detection wiring 44 is disposed between the first coupling region Ac1 and the mounted component 210, the region in which the detection wiring 44, the first relay wiring 45, and the second relay wiring 46 are disposed can be reduced.

In addition, the liquid being adhered to the flexible substrate 4 is likely to accumulate on the side surface of the mounted component 210 protruding from the surface of the flexible substrate 4 in the Z2 direction. Therefore, as illustrated in FIG. 7, the liquid can easily adhere to the detection wiring 44 by disposing the detection wiring 44 closer to the mounted component 210 than the first coupling region Ac1. As a result, in the present embodiment, it is possible to easily detect that the flexible substrate 4 is exposed to a high-humidity environment at an early stage.

The configuration of the flexible substrate 4 is not limited to the example illustrated in FIG. 7. For example, the detection wiring 44 may be provided at a position between the first coupling region Ac1 and the mounted component 210, other than the center portion of the base film 400 along the Y axis. In addition, for example, the resistance wiring portion 44a may be disposed in a serpentine shape so as to reciprocate a plurality of times along the Y axis, or may not be disposed in a serpentine shape. In addition, for example, the first wiring portion 44b may be regarded as a part of the first relay wiring 45. Similarly, the second wiring portion 44c may be regarded as a part of the second relay wiring 46. When the first wiring portion 44b is regarded as a part of the first relay wiring 45 and the second wiring portion 44c is regarded as a part of the second relay wiring 46, the resistance wiring portion 44a corresponds to the “detection wiring”.

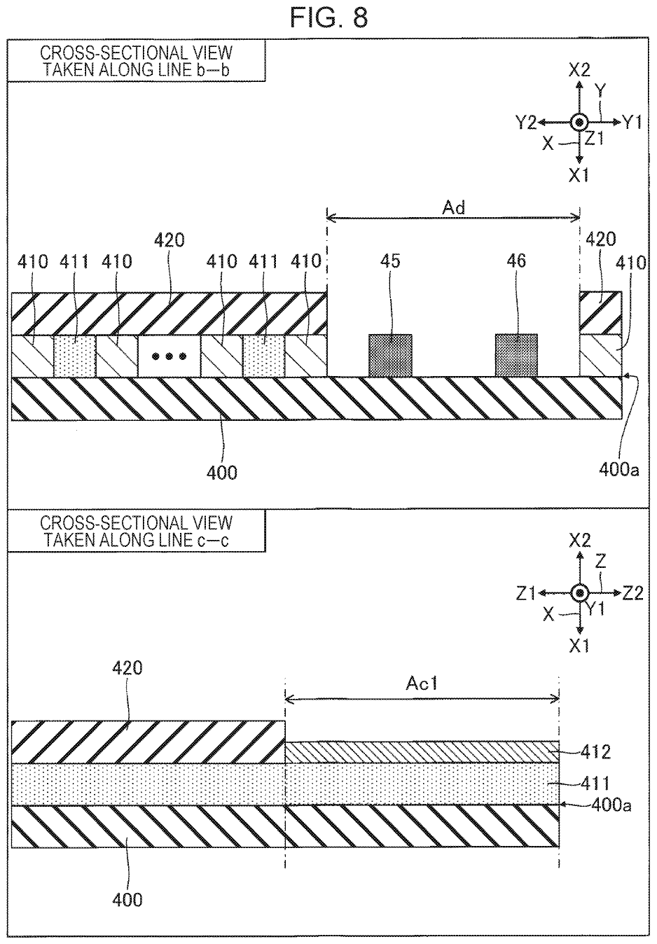

In addition, a line b-b in FIG. 7 indicates a cross section portion of a cross-sectional view illustrated in an upper part in FIG. 8, and a line c-c in FIG. 7 indicates a cross section portion of a cross-sectional view illustrated in a lower part in FIG. 8.

FIG. 8 is a cross-sectional view illustrating a part of the flexible substrate 4. The upper part in FIG. 8 schematically illustrates a cross section of the flexible substrate 4 taken along the line b-b in FIG. 7, and the lower part in FIG. 8 schematically illustrates a cross section of the flexible substrate 4 taken along the line c-c in FIG. 7.

As illustrated in the cross-sectional view taken along the line b-b in FIG. 7, the plurality of electric wirings 411, the first relay wiring 45, the second relay wiring 46, and the like are disposed on the mounting surface 400a of the base film 400. The cover film 420 is adhered to the base film 400 by an adhesive layer 410 so as to interpose the plurality of electric wirings 411, and the plurality of drive signal wirings 41 and the plurality of constant voltage wirings 42 illustrated in FIG. 7 between the cover film 420 and the mounting surface 400a of the base film 400. As a result, the plurality of electric wirings 411, and the plurality of drive signal wirings 41 and the plurality of constant voltage wirings 42 illustrated in FIG. 7 are covered with the cover film 420. The first relay wiring 45, the second relay wiring 46, and the detection wiring 44 illustrated in FIG. 8 are not covered with the cover film 420 because these wirings are disposed in the detection region Ad corresponding to a notch portion of the cover film 420. The adhesive layer 410 may be provided between the wiring provided on the mounting surface 400a of the base film 400 and the base film 400, and between the wiring covered with the cover film 420 and the cover film 420.

In addition, as illustrated in the cross-sectional view taken along the line c-c in FIG. 7, a film 412, such as gold (Au), is formed at the surface of the electric wiring 411 of the portion disposed in the first coupling region Ac1 of the electric wiring 411 by surface treatment, such as plating. The film 412 may be regarded as a part of the electric wiring 411.

In addition, the surface treatment, such as plating, is also performed on the surface of the constant voltage wiring 42 of the portion disposed in the first coupling region Ac1 and the second coupling region Ac2, and the surface of the drive signal wiring 41 of the portion disposed in the second coupling region Ac2. The surface treatment, such as plating, may be performed on the first relay wiring 45 and the second relay wiring 46, or may be performed on the detection wiring 44.

### 1-6. Summary of First Embodiment

Hereinbefore, in the present embodiment, the liquid ejecting head 200 includes the piezoelectric substrate 30 that has the plurality of piezoelectric elements E for ejecting the liquid, the wiring substrate 27, and the flexible substrate 4 that electrically couples the piezoelectric substrate 30 and the wiring substrate 27. The flexible substrate 4 includes a base film 400 that has a mounting surface 400a, the plurality of wirings disposed on the mounting surface 400a, the insulating cover film 420 that covers the plurality of wirings so as to interpose the plurality of wirings between the cover film 420 and the mounting surface 400a, and the detection wiring 44 disposed on the mounting surface 400a at a position not covered with the cover film 420, and for detecting that a liquid is adhered to the detection wiring 44.

As described above, in the present embodiment, the detection wiring 44 not covered with the cover film 420 is provided. Therefore, in the present embodiment, it is possible to detect that the flexible substrate 4 is exposed to a high-humidity environment at an early stage by detecting that the liquid is adhered to the detection wiring 44. As a result, in the present embodiment, it is possible to prevent the flexible substrate 4 from failing when the liquid ejecting head 200 is continuously used in a high-humidity environment. For example, in the present embodiment, when it is detected that the liquid is in a state of being adhered to the detection wiring 44, it is possible to improve the environment in which migration and electrolytic corrosion are likely to occur by promoting ventilation in the liquid ejecting head 200 or the liquid ejecting apparatus 100. In addition, in the present embodiment, it is possible to detect the abnormality of the liquid ejecting head 200 that unintended wet air enters by detecting that the liquid is adhered to the detection wiring 44.

In addition, in the present embodiment, the flexible substrate 4 may include the mounted component 210 that has the drive signal selection circuit 21 selecting whether or not to supply the drive signal Vout to each of the plurality of piezoelectric elements E, and the first coupling region Ac1 coupled to the wiring substrate 27. In the present aspect, the detection wiring 44 is disposed between the first coupling region Ac1 and the mounted component 210. Therefore, in the present aspect, the region in which the detection wiring 44 is disposed can be reduced.

In addition, in the present embodiment, the flexible substrate 4 includes the second coupling region Ac2 coupled to the piezoelectric substrate 30 and the wiring region Aw between the first coupling region Ac1 and the second coupling region Ac2. The wiring region Aw extends in the gravity direction. For example, the liquid being adhered to the flexible substrate 4 moves in the gravity direction and is likely to accumulate on the mounted component 210 protruding in the X2 direction from the surface of the flexible substrate 4, specifically, the surface facing X2 direction of the cover film 420 covering the plurality of wirings in the wiring region Aw. Therefore, in the present aspect, it is possible to easily detect that the flexible substrate 4 is exposed to a high-humidity environment at an early stage by detecting that the liquid is adhered to the detection wiring 44 disposed between the first coupling region Ac1 and the mounted component 210.

In addition, in the present embodiment, the detection wiring 44 may be disposed closer to the mounted component 210 than the first coupling region Ac1. In the present aspect, it is possible to easily detect that the flexible substrate 4 is exposed to a high-humidity environment at an early stage by detecting that the liquid is adhered to the detection wiring 44 disposed closer to the mounted component 210 than the first coupling region Ac1.

In addition, in the present embodiment, the detection wiring 44 is disposed between one end and the other end of the cover film 420 in the direction from the second coupling region Ac2 to the first coupling region Ac1. For example, the detection wiring 44 is disposed in the detection region Ad, which is a region different from the region in which the plurality of electric wirings 411, the plurality of drive signal wirings 41, and the plurality of constant voltage wirings 42 are exposed, in the wiring region Aw. In the present embodiment, it is possible to detect that the flexible substrate 4 is exposed to a high-humidity environment at an early stage by detecting that the liquid is adhered to the detection wiring 44 disposed between one end and the other end of the cover film 420.

In addition, in the present embodiment, the liquid ejecting head 200 may include the detection circuit 25 that outputs the detection signal Vd for detecting the state of the detection wiring 44. In the present aspect, it is possible to detect that the liquid is adhered to the detection wiring 44 based on the detection signal Vd output from the detection circuit 25.

In addition, in the present embodiment, the liquid ejecting apparatus 100 includes the liquid ejecting head 200 described above, and the control circuit 11 that determines whether or not the liquid is in a state of being adhered to the detection wiring 44 based on the detection signal Vd. In the present aspect, the liquid ejecting apparatus 100 can detect that the flexible substrate 4 is exposed to a high-humidity environment at an early stage by detecting that the liquid is adhered to the detection wiring 44. As a result, in the present aspect, it is possible to prevent the flexible substrate 4 from failing when the liquid ejecting head 200 is continuously used in a high-humidity environment.

In addition, in the present embodiment, the liquid ejecting apparatus 100 may include a notification portion that notifies of an abnormality when the control circuit 11 determines that the liquid is in a state of being adhered to the detection wiring 44. As a result, in the present aspect, it is possible to prevent the flexible substrate 4 from failing when the liquid ejecting head 200 is continuously used in a high-humidity environment.

### 2. MODIFICATION EXAMPLE

Each embodiment above can be modified in various manners. A specific aspect of the modification is described below. Two or more aspects selected in any manner from the following examples can be appropriately combined with one another within a range not inconsistent with one another. In modification examples to be described below, elements having the same effects and functions as those of the embodiment will be given the reference numerals used in the above description, and each detailed description thereof will be appropriately omitted.

### 2-1. First Modification Example

In the above-described embodiment, a case where the detection wiring 44 is disposed between the first coupling region Ac1 and the mounted component 210 is exemplified, but the present disclosure is not limited to such an aspect. For example, the detection wiring 44 may be disposed in the vicinity of the second coupling region Ac2.

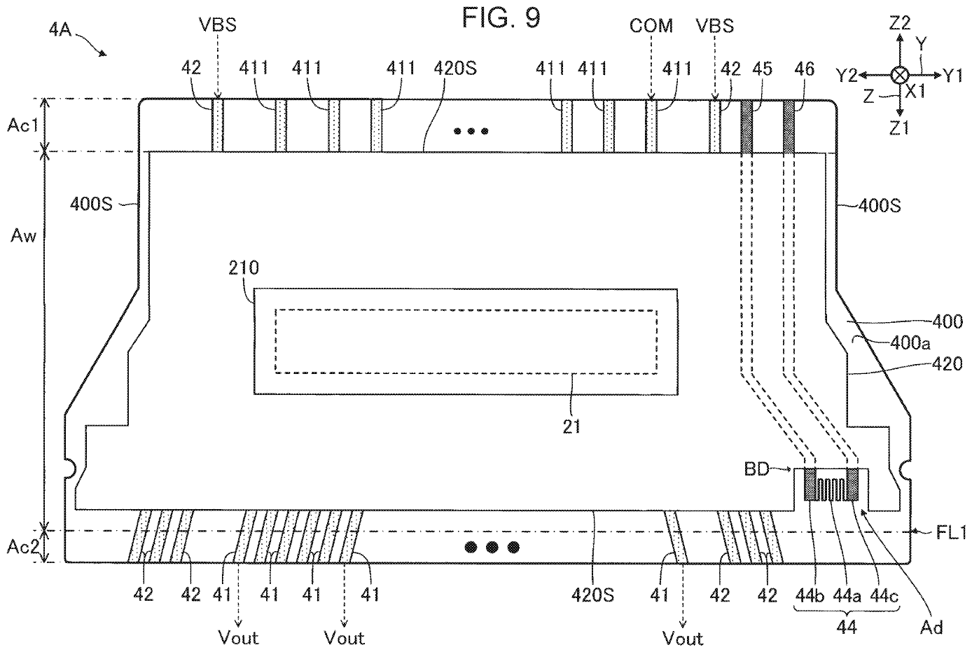

FIG. 9 is a diagram illustrating a flexible substrate 4A according to a first modification example. In FIG. 9, the first relay wiring 45 and the second relay wiring 46 in the portion covered with the cover film 420 are illustrated by broken lines in order to facilitate the description. The flexible substrate 4A is the same as the flexible substrate 4 illustrated in FIG. 7 except that the detection wiring 44, the first relay wiring 45, and the second relay wiring 46 are disposed. In addition, the liquid ejecting module 20 according to the present modification example is the same as the liquid ejecting module 20 according to the above-described embodiment, except that the flexible substrate 4A is provided instead of the flexible substrate 4 illustrated in FIG. 7. In FIG. 9, the description will focus on the difference of the flexible substrate 4A with respect to the flexible substrate 4.

In the flexible substrate 4A, the detection wiring 44 is disposed in the vicinity of the second coupling region Ac2. For example, the vicinity of the second coupling region Ac2 corresponds to a final point where the liquid being adhered to the flexible substrate 4A drips along the flexible substrate 4A and finally reaches, or to the vicinity of the final point. For example, the vicinity of the second coupling region Ac2 is a region closer to the second coupling region Ac2 than the first coupling region Ac1. In addition, for example, the vicinity of the second coupling region Ac2 may be a region where the range of the Z axis is included between the mounted component 210 and the second coupling region Ac2. Alternatively, the vicinity of the second coupling region Ac2 may be the lowermost region when the wiring region Aw is divided into three parts, more preferably, into five parts in the gravity direction.

In the present modification example, since the detection wiring 44 is disposed in the vicinity of the second coupling region Ac2, the liquid being adhered to the flexible substrate 4A is likely to drip along the flexible substrate 4A and adhere to the detection wiring 44. Therefore, in the present modification example, it is possible to easily detect that the flexible substrate 4 is exposed to a high-humidity environment at an early stage by detecting that the liquid is adhered to the detection wiring 44 disposed in the vicinity of the second coupling region Ac2.

In the example illustrated in FIG. 9, the detection wiring 44 is disposed in the detection region Ad partitioned by a notch formed at the end portion of the cover film 420 in the Z1 direction. For example, the side of the notch of the cover film 420 in the Z2 direction corresponds to the boundary BD between the first relay wiring 45 and the first wiring portion 44b of the detection wiring 44, and the boundary BD between the second relay wiring 46 and the second wiring portion 44c of the detection wiring 44. For example, the boundary BD may be a position corresponding to the end portion of the resistance wiring portion 44a in the Z2 direction. In the example illustrated in FIG. 9, the first relay wiring 45 and the second relay wiring 46 of the portion disposed in the wiring region Aw are covered with the cover film 420.

As described above, a part of each of the first relay wiring 45 and the second relay wiring 46 disposed on the mounting surface 400a of the flexible substrate 4A is covered with the cover film 420. As a result, for example, it is possible to reduce the risk that the portion of the wiring disposed in the wiring region Aw and not covered with the cover film 420 comes into contact with the inner peripheral surface of the through-hole 60C of the metal liquid distribution portion 60 or a metal heat dissipation plate (not illustrated) for cooling the mounted component 210 and is conducted.

In addition, in the example illustrated in FIG. 9, the detection wiring 44, the first relay wiring 45, and the second relay wiring 46 are disposed outside a group of the plurality of drive signal wirings 41 and the plurality of constant voltage wirings 42. That is, the detection wiring 44, the first relay wiring 45, and the second relay wiring 46 are provided on the outermost side of the flexible substrate 4A along the Y axis. The end portion of the flexible substrate 4A in the direction along the Y axis is more likely to be exposed to a high-humidity environment than a center portion of the flexible substrate 4A in the direction along the Y axis. Therefore, in the present modification example, it is possible to detect that the flexible substrate 4 is exposed to a high-humidity environment at an early stage by detecting that the liquid is adhered to the detection wiring 44 disposed at the outermost side along the Y axis of the flexible substrate 4A.

The configuration of the flexible substrate 4A is not limited to the example illustrated in FIG. 9. For example, the detection wiring 44, the first relay wiring 45, and the second relay wiring 46 may be disposed between the group of the plurality of drive signal wirings 41 and the group of the plurality of constant voltage wirings 42. In addition, for example, the first wiring portion 44b may be regarded as a part of the first relay wiring 45, and the second wiring portion 44c may be regarded as a part of the second relay wiring 46. In addition, for example, the first relay wiring 45 and the second relay wiring 46 may not be covered with the cover film 420. In the aspect in which the first relay wiring 45 and the second relay wiring 46 are not covered with the cover film 420, a portion disposed in the wiring region Aw of the first relay wiring 45 and the second relay wiring 46 may be regarded as a part of the detection wiring 44.

As described above, in the present modification example as well, the same effects as those of the embodiment described above can be obtained. In addition, in the present modification example, the detection wiring 44 is disposed in the vicinity of the second coupling region Ac2 in the wiring region Aw extending along the gravity direction. As a result, in the present modification example, the liquid can easily adhere to the detection wiring 44.

In addition, in the present modification example, one end of each of the first relay wiring 45 and the second relay wiring 46 is disposed in the first coupling region Ac1, and the other end of each of the first relay wiring 45 and the second relay wiring 46 is coupled to the detection wiring 44. A part of each of the first relay wiring 45 and the second relay wiring 46 may be covered with the cover film 420. In the aspect in which a part of each of the first relay wiring 45 and the second relay wiring 46 is covered with the cover film 420, it is possible to reduce the risk that the first relay wiring 45 and the second relay wiring 46 come into contact with the inner peripheral surface of the through-hole 60C of the metal liquid distribution portion 60 or the metal heat dissipation plate (not illustrated) for cooling the mounted component 210 and are conducted.

### 2-2. Second Modification Example

In the above-described embodiment and modification example, a case where the detection wiring 44 includes the resistance wiring portion 44a is exemplified, but the present disclosure is not limited to such an aspect. For example, the detection wiring 44 may not include the resistance wiring portion 44a.

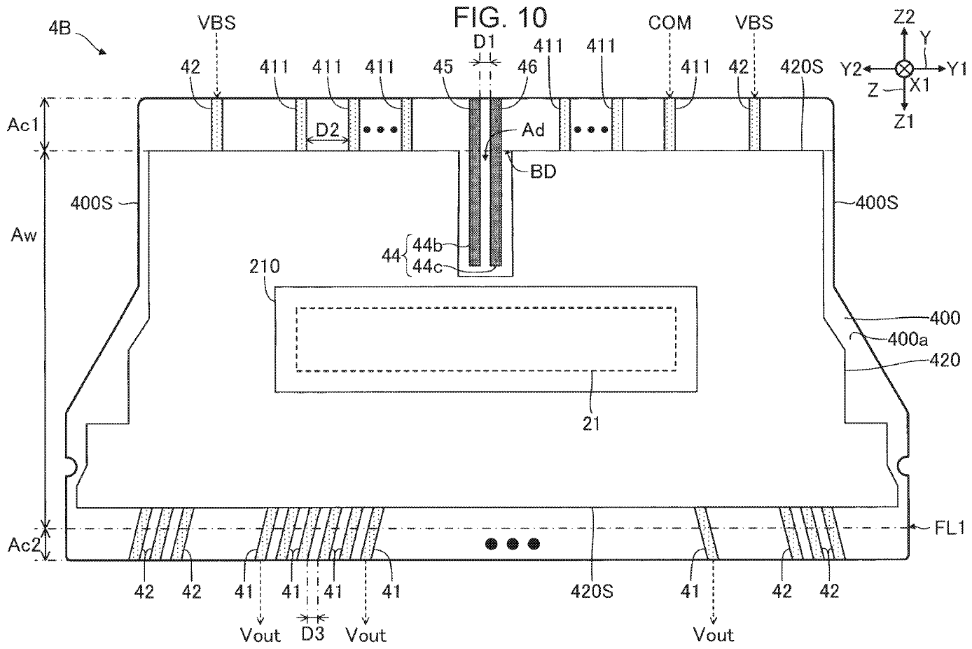

FIG. 10 is a diagram illustrating a flexible substrate 4B according to a second modification example. The flexible substrate 4B is the same as the flexible substrate 4 illustrated in FIG. 7 except that the detection wiring 44 does not include the resistance wiring portion 44a. In addition, the liquid ejecting module 20 according to the present modification example is the same as the liquid ejecting module 20 according to the above-described embodiment, except that the flexible substrate 4B is provided instead of the flexible substrate 4 illustrated in FIG. 7. In FIG. 10, the description will focus on the difference of the flexible substrate 4B with respect to the flexible substrate 4.

In the flexible substrate 4B, the detection wiring 44 includes a first wiring portion 44b and a second wiring portion 44c that extend in the direction along the Z axis. The end portion of the first wiring portion 44b in the Z2 direction is coupled to the first relay wiring 45, and the end portion of the first wiring portion 44b in the Z1 direction is disposed between the first coupling region Ac1 and the mounted component 210, and is open. The end portion of the second wiring portion 44c in the Z2 direction is coupled to the second relay wiring 46, and the end portion of the second wiring portion 44c in the Z1 direction is disposed between the first coupling region Ac1 and the mounted component 210, and is open. For example, the position of the Z axis of the boundary BD between the first relay wiring 45 and the first wiring portion 44b of the detection wiring 44, and the boundary BD between the second relay wiring 46 and the second wiring portion 44c of the detection wiring 44 is the same as the position of the end side 420S of the cover film 420 in the Z2 direction. That is, the boundary between the first coupling region Ac1 and the wiring region Aw corresponds to the boundary BD between the first relay wiring 45 and the first wiring portion 44b of the detection wiring 44, and the boundary BD between the second relay wiring 46 and the second wiring portion 44c of the detection wiring 44.

In addition, the first wiring portion 44b and the second wiring portion 44c of the detection wiring 44 are arranged side by side along the Y axis at intervals from each other. For example, when the liquid is adhered across the first wiring portion 44b and the second wiring portion 44c of the detection wiring 44, a current flows through the liquid, and thus the first wiring portion 44b and the second wiring portion 44c are conducted. That is, when the liquid is adhered across the first wiring portion 44b and the second wiring portion 44c of the detection wiring 44, the first relay wiring 45 and the second relay wiring 46 are conducted via the liquid, the first wiring portion 44b, and the second wiring portion 44c. Therefore, when the liquid is adhered across the first wiring portion 44b and the second wiring portion 44c of the detection wiring 44, the current flows between the first relay wiring 45 and the second relay wiring 46 via the liquid, the first wiring portion 44b, and the second wiring portion 44c. For example, the detection circuit 25 may output the detection signal Vd corresponding to the current flowing through the first relay wiring 45 or the second relay wiring 46 to the control unit 10, or may output the detection signal Vd corresponding to the voltage between the first relay wiring 45 and the second relay wiring 46 to the control unit 10.

As described above, the detection signal Vd indicates the degree of conduction between the first wiring portion 44b and the second wiring portion 44c. For example, the degree of conduction between the first wiring portion 44b and the second wiring portion 44c corresponds to the electric resistance between the first wiring portion 44b and the second wiring portion 44c. Therefore, the control circuit 11 of the control unit 10 can determine whether or not the liquid is in a state of being adhered to the detection wiring 44 based on the detection signal Vd indicating the degree of conduction between the first wiring portion 44b and the second wiring portion 44c.

It is preferable that the conduction between the first wiring portion 44b and the second wiring portion 44c due to the liquid being adhered to the detection wiring 44 occurs before the conduction between the electric wirings 411 due to the liquid being adhered to the electric wirings 411 adjacent to each other. From this viewpoint, an interval D1 between the first wiring portion 44b and the second wiring portion 44c is preferably narrower than an interval D2 between the electric wirings 411 adjacent to each other. In addition, it is preferable that the conduction between the first wiring portion 44b and the second wiring portion 44c due to the liquid being adhered to the detection wiring 44 occurs before the conduction between the drive signal wirings 41 due to the liquid being adhered to the drive signal wirings 41 adjacent to each other. From this viewpoint, the interval D1 between the first wiring portion 44b and the second wiring portion 44c is preferably narrower than an interval D3 between the drive signal wirings 41 adjacent to each other.

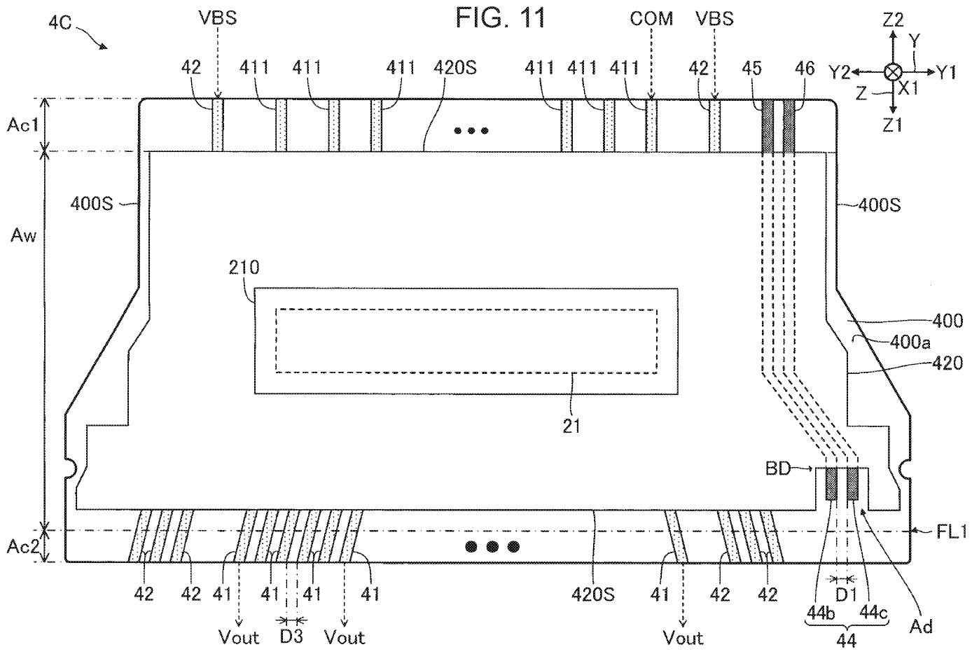

The configuration of the flexible substrate 4B is not limited to the example illustrated in FIG. 10. For example, the detection wiring 44 may be provided at a position between the first coupling region Ac1 and the mounted component 210, other than the center portion of the base film 400 along the Y axis. In addition, for example, the first relay wiring 45 may be regarded as a part of the first wiring portion 44b, and the second relay wiring 46 may be regarded as a part of the second wiring portion 44c. That is, each of the two wirings wired from the first coupling region Ac1 to a space between the first coupling region Ac1 and the mounted component 210, and arranged side by side along the Y axis at intervals from each other may be regarded as the first wiring portion 44b and the second wiring portion 44c. In addition, as illustrated in FIG. 11, the detection wiring 44 that does not include the resistance wiring portion 44a may be disposed in the vicinity of the second coupling region Ac2.

FIG. 11 is a diagram illustrating a flexible substrate 4C according to another example of the second modification example. In FIG. 11, the first relay wiring 45 and the second relay wiring 46 in the portion covered with the cover film 420 are illustrated by broken lines in order to facilitate the description. The flexible substrate 4C is the same as the flexible substrate 4A illustrated in FIG. 9 except that the detection wiring 44 does not include the resistance wiring portion 44a. In addition, the liquid ejecting module 20 according to the present modification example is the same as the liquid ejecting module 20 according to the above-described embodiment, except that the flexible substrate 4C is provided instead of the flexible substrate 4 illustrated in FIG. 7. In addition, in the flexible substrate 4C, the preferable conditions of the interval D1 between the first wiring portion 44b and the second wiring portion 44c are the same as those of the flexible substrate 4B illustrated in FIG. 10. For example, the interval D1 between the first wiring portion 44b and the second wiring portion 44c is preferably narrower than the interval D3 between the adjacent drive signal wirings 41 among the plurality of drive signal wirings 41.

As described above, in the present modification example as well, the same effects as those of the embodiment and modification example described above can be obtained.

### 2-3. Third Modification Example

In the above-described embodiment, a case where the detection circuit 25 is mounted on the wiring substrate 27 is exemplified, but the present disclosure is not limited to such an aspect. For example, the mounted component 210 including the drive signal selection circuit 21 may include the detection circuit 25 that outputs the detection signal Vd for detecting the state of the detection wiring 44.

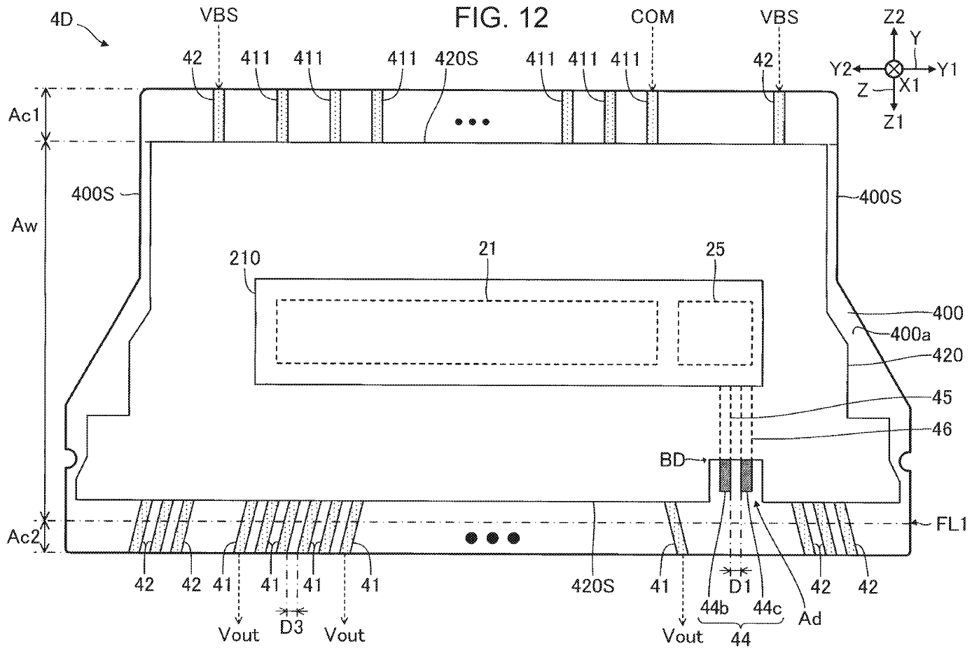

FIG. 12 is a diagram illustrating a flexible substrate 4D according to a third modification example. In FIG. 12, the first relay wiring 45 and the second relay wiring 46 in the portion covered with the cover film 420 are illustrated by broken lines in order to facilitate the description. The flexible substrate 4D is the same as the flexible substrate 4C illustrated in FIG. 11 except that the detection wiring 44, the first relay wiring 45, and the second relay wiring 46 are disposed, and the mounted component 210 is included in the detection circuit 25. In addition, the liquid ejecting module 20 according to the present modification example is the same as the liquid ejecting module 20 according to the above-described embodiment, except that the flexible substrate 4D is provided instead of the flexible substrate 4 illustrated in FIG. 7. In FIG. 12, the description will focus on the difference of the flexible substrate 4D with respect to the flexible substrate 4C.

In the present modification example, for example, the detection circuit 25 illustrated in FIG. 2 is omitted from the wiring substrate 27, and is included in the mounted component 210. The detection wiring 44 includes a first wiring portion 44b and a second wiring portion 44c that extend in the direction along the Z axis. The detection wiring 44 is disposed in the detection region Ad partitioned by the notch formed at the end portion of the cover film 420 in the Z1 direction. The first relay wiring 45 is wired from the mounted component 210 including the detection circuit 25 to the first wiring portion 44b, and couples the mounted component 210 and the first wiring portion 44b. The second relay wiring 46 is wired from the mounted component 210 including the detection circuit 25 to the second wiring portion 44c, and couples the mounted component 210 and the second wiring portion 44c. As a result, the first wiring portion 44b and the second wiring portion 44c of the detection wiring 44 are electrically coupled to the detection circuit 25.

In addition, the detection wiring 44, the first relay wiring 45, and the second relay wiring 46 are disposed between the group of the plurality of drive signal wirings 41 and the group of the plurality of constant voltage wirings 42. That is, the detection wiring 44, the first relay wiring 45, and the second relay wiring 46 are disposed outside the plurality of drive signal wirings 41.

In addition, in the flexible substrate 4D, the preferable conditions of the interval D1 between the first wiring portion 44b and the second wiring portion 44c are the same as those of the flexible substrate 4B illustrated in FIG. 10. For example, the interval D1 between the first wiring portion 44b and the second wiring portion 44c is preferably narrower than the interval D3 between the adjacent drive signal wirings 41 among the plurality of drive signal wirings 41.

The configuration of the flexible substrate 4D is not limited to the example illustrated in FIG. 12. For example, the detection wiring 44 may include the resistance wiring portion 44a as in the detection wiring 44 illustrated in FIG. 9. In addition, for example, the detection wiring 44, the first relay wiring 45, and the second relay wiring 46 may be disposed at the center portion of the base film 400 along the Y axis. In addition, for example, the detection wiring 44 may be disposed between the first coupling region Ac1 and the mounted component 210 as in the detection wiring 44 in FIG. 7 or FIG. 10. In the aspect in which the detection wiring 44 is disposed between the first coupling region Ac1 and the mounted component 210, the first relay wiring 45 is wired from the mounted component 210 to the first wiring portion 44b, and the second relay wiring 46 is wired from the mounted component 210 to the second wiring portion 44c. In addition, in the aspect in which the detection wiring 44 is disposed between the first coupling region Ac1 and the mounted component 210, a through-hole may be formed in the cover film 420, and the detection region Ad may be partitioned by the through-hole.

As described above, in the present modification example as well, the same effects as those of the embodiment described above can be obtained. In addition, in the present modification example, since the detection circuit 25 is included in the mounted component 210, a space for disposing the detection wiring 44, the first relay wiring 45, and the second relay wiring 46 can be easily secured.

### 2-4. Fourth Modification Example

In the above-described embodiment and modification example, a case where the detection region Ad in which the detection wiring 44 is disposed is partitioned by the notch formed in the cover film 420 is exemplified, but the present disclosure is not limited to such an aspect. For example, a through-hole may be formed in the cover film 420, and the detection region Ad may be partitioned by the through-hole.

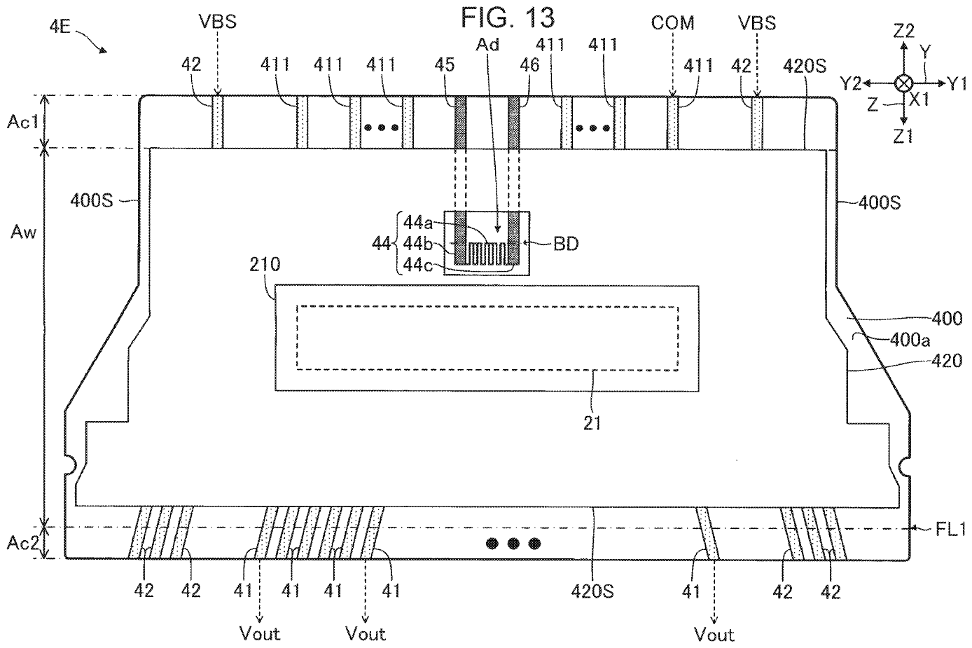

FIG. 13 is a diagram illustrating a flexible substrate 4E according to a fourth modification example. In FIG. 13, the first relay wiring 45 and the second relay wiring 46 in the portion covered with the cover film 420 are illustrated by broken lines in order to facilitate the description. The flexible substrate 4E is the same as the flexible substrate 4 illustrated in FIG. 7 except that the detection region Ad is partitioned by a through-hole formed in the cover film 420. In addition, the liquid ejecting module 20 according to the present modification example is the same as the liquid ejecting module 20 according to the above-described embodiment, except that the flexible substrate 4E is provided instead of the flexible substrate 4 illustrated in FIG. 7. The boundary BD between the first relay wiring 45 and the first wiring portion 44b of the detection wiring 44, and the boundary BD between the second relay wiring 46 and the second wiring portion 44c of the detection wiring 44 may be the boundary between the portion covered with the cover film 420 and the detection region Ad in the Z2 direction.

As described above, in the present modification example as well, the same effects as those of the embodiment and modification example described above can be obtained.

### 2-5. Fifth Modification Example

In the above-described embodiment, a case where the resistance wiring portion 44a of the detection wiring 44 is disposed between the first wiring portion 44b and the second wiring portion 44c is exemplified, but the present disclosure is not limited to such an aspect. For example, the resistance wiring portion 44a of the detection wiring 44 may be disposed to protrude in one of the Y1 direction and the Y2 direction with respect to the first relay wiring 45 and the second relay wiring 46, and to reciprocate along the Y axis.

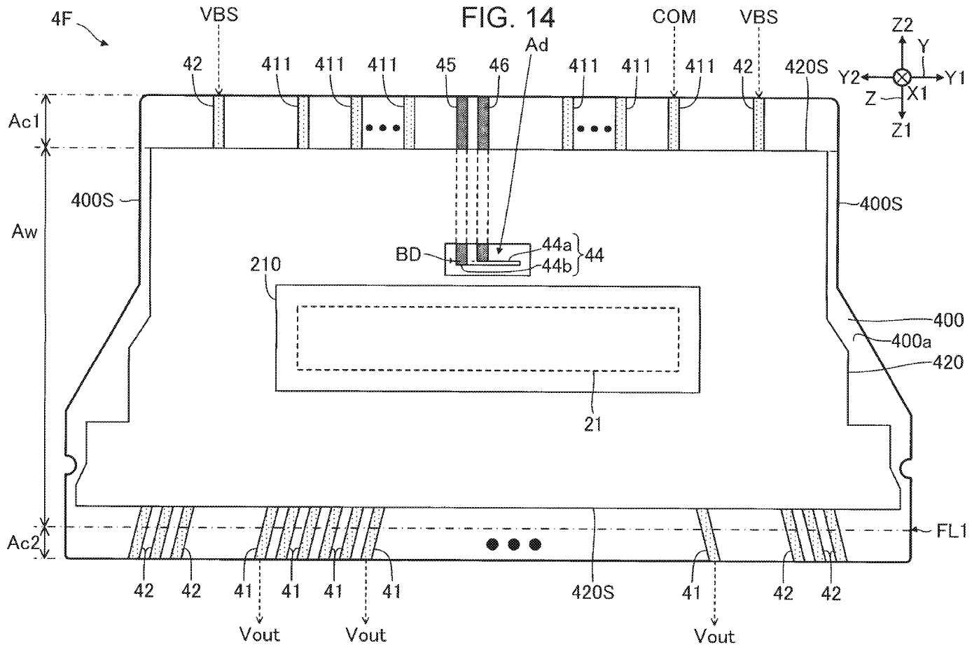

FIG. 14 is a diagram illustrating a flexible substrate 4F according to a fifth modification example. In FIG. 14, the first relay wiring 45 and the second relay wiring 46 in the portion covered with the cover film 420 are illustrated by broken lines in order to facilitate the description. The flexible substrate 4F is the same as the flexible substrate 4E illustrated in FIG. 13 except that the flexible substrate 4F is provided with the resistance wiring portion 44a disposed to protrude in the Y1 direction with respect to the first relay wiring 45 and the second relay wiring 46 instead of the resistance wiring portion 44a illustrated in FIG. 13. In addition, the liquid ejecting module 20 according to the present modification example is the same as the liquid ejecting module 20 according to the above-described embodiment, except that the flexible substrate 4F is provided instead of the flexible substrate 4 illustrated in FIG. 7.

Each of the first relay wiring 45 and the second relay wiring 46 is wired from the first coupling region Ac1 to the detection region Ad partitioned by the through-hole formed in the cover film 420. In addition, the first relay wiring 45 and the second relay wiring 46 are arranged side by side along the Y axis at intervals from each other. The detection wiring 44 includes the first wiring portion 44b coupled to the first relay wiring 45, and the resistance wiring portion 44a coupled to the first wiring portion 44b and the second relay wiring 46. The resistance wiring portion 44a is disposed to protrude in the Y1 direction with respect to the first relay wiring 45 and the second relay wiring 46, and to reciprocate along the Y axis. In the example illustrated in FIG. 14, the position of the Z axis of the boundary BD between the first relay wiring 45 and the first wiring portion 44b of the detection wiring 44, and the boundary BD between the second relay wiring 46 and the second wiring portion 44c of the detection wiring 44 is the same as the position of the end portion of the resistance wiring portion 44a in the Z2 direction. In this case, since the resistance wiring portion 44a is coupled to the second relay wiring 46, the second wiring portion 44c illustrated in FIG. 13 and the like is not present. However, each of the wirings other than the resistance wiring portion 44a of the wirings in the detection region Ad, that is, each of the two wirings arranged side by side along the Y axis at intervals from each other in the detection region Ad may be regarded as the first wiring portion 44b and the second wiring portion 44c. That is, the boundary BD between the first relay wiring 45 and the first wiring portion 44b of the detection wiring 44, and the boundary BD between the second relay wiring 46 and the second wiring portion 44c of the detection wiring 44 may be the boundary between the portion covered with the cover film 420 and the detection region Ad in the Z2 direction.

The configuration of the flexible substrate 4F is not limited to the example illustrated in FIG. 14. For example, the resistance wiring portion 44a may be disposed to protrude in the Y2 direction with respect to the first relay wiring 45 and the second relay wiring 46, and to reciprocate along the Y axis. In addition, the flexible substrate 4C illustrated in FIG. 11, the flexible substrate 4D illustrated in FIG. 12, and the like may be provided with the resistance wiring portion 44a that protrudes in one of the Y1 direction and the Y2 direction with respect to the first relay wiring 45 and the second relay wiring 46, and is disposed to reciprocate along the Y axis. In addition, for example, the first wiring portion 44b may be regarded as a part of the first relay wiring 45. In addition, the detection region Ad in which the detection wiring 44 is disposed may be partitioned by the notch formed in the cover film 420 instead of the through-hole formed in the cover film 420.

As described above, in the present modification example as well, the same effects as those of the embodiment and modification example described above can be obtained.

### 2-6. Sixth Modification Example

In the above-described embodiment and modification example, a case where the liquid ejecting head 200 includes the detection circuit 25 is exemplified, but the present disclosure is not limited to such an aspect. For example, the liquid ejecting apparatus 100 may include the liquid ejecting head 200 in which the detection circuit 25 is omitted, and the detection circuit 25 provided outside the liquid ejecting head 200. Specifically, for example, the detection circuit 25 may be included in the control unit 10. In addition, in the present modification example, the liquid ejecting apparatus 100 may include a notification portion that notifies of an abnormality when the control circuit 11 determines that the liquid is in a state of being adhered to the detection wiring 44.

As described above, in the present modification example as well, the same effects as those of the embodiment and modification example described above can be obtained.

### 2-7. Seventh Modification Example

In the above-described embodiment and modification example, a plurality of detection wirings 44 may be provided. In the present modification example as well, the same effects as those of the embodiment and modification examples described above can be obtained. In addition, in the present modification example, since the plurality of detection wirings 44 are provided, it is possible to detect that the flexible substrate 4 is exposed to a high-humidity environment at an early stage.

### 2-8. Eighth Modification Example

In the above-described embodiment and modification example, the control circuit 11 may detect the humid environment of the space accommodating the flexible substrate 4 in a stepwise manner, based on the detection signal Vd indicating the change in the current flowing through the first relay wiring 45 or the second relay wiring 46, or the change in the voltage of the first relay wiring 45 or the second relay wiring 46. As described above, in the present modification example as well, the same effects as those of the embodiment and modification example described above can be obtained.

### 2-9. Ninth Modification Example

In the above-described embodiment and modification example, a case where the liquid ejecting head 200 includes six liquid ejecting modules 20 is exemplified, but the present disclosure is not limited to such an aspect. For example, the liquid ejecting head 200 may include one or more and five or less liquid ejecting modules 20, or may include seven or more liquid ejecting modules 20. In the present modification example as well, the same effects as those of the embodiment described above can be obtained.

### 2-10. Tenth Modification Example

The liquid ejecting apparatus 100 described in the embodiment and modification examples described above can be adopted in various types of devices, such as a facsimile machine and a copying machine, in addition to a device dedicated to printing. However, the application of the liquid ejecting apparatus of the present disclosure is not limited to printing. For example, a liquid ejecting apparatus that ejects a solution of a coloring material is used as a manufacturing apparatus that forms a color filter of a display device, such as a liquid crystal display panel. In addition, a liquid ejecting apparatus that ejects a solution of a conductive material is used as a manufacturing apparatus that forms wiring or an electrode of a wiring substrate. In addition, for example, a liquid ejecting apparatus that ejects a solution of an organic material related to a living body is used as a manufacturing apparatus that manufactures a biochip. In the present modification example as well, the same effects as those of the embodiment and modification examples described above can be obtained.

### 3. APPENDIX

From the embodiments described above, for example, the following configurations are grasped.

According to a first aspect, which is the preferred aspect, there is provided a liquid ejecting head including an actuator substrate that includes a plurality of drive elements for ejecting a liquid, a wiring substrate, and a flexible substrate that electrically couples the actuator substrate and the wiring substrate, in which the flexible substrate includes a base film that has a mounting surface, a plurality of wirings disposed on the mounting surface, an insulating cover film that covers the plurality of wirings so as to interpose the plurality of wirings between the cover film and the mounting surface, and a detection wiring disposed on the mounting surface at a position not covered with the cover film, and for detecting that the liquid is adhered to the detection wiring. According to the first aspect, it is possible to detect that the flexible substrate is exposed to a high-humidity environment at an early stage by detecting that the liquid is adhered to the detection wiring.

In the liquid ejecting head according to a second aspect, which is a specific example of the first aspect, the flexible substrate includes a drive component that has a selection circuit selecting whether or not to supply a drive signal to each of the plurality of drive elements, and a first coupling region coupled to the wiring substrate, and the detection wiring is disposed between the first coupling region and the drive component. According to the second aspect, in the present aspect, the region in which the detection wiring is disposed can be reduced.

In the liquid ejecting head according to a third aspect, which is a specific example of the second aspect, the flexible substrate includes a second coupling region coupled to the actuator substrate, and a wiring region disposed between the first coupling region and the second coupling region, and the wiring region extends in a gravity direction. According to the third aspect, it is possible to easily detect that the flexible substrate 4 is exposed to a high-humidity environment at an early stage.

In the liquid ejecting head according to a fourth aspect, which is a specific example of the second or third aspect, the detection wiring is disposed closer to the drive component than the first coupling region. According to the fourth aspect, it is possible to easily detect that the flexible substrate 4 is exposed to a high-humidity environment at an early stage.

In the liquid ejecting head according to a fifth aspect, which is a specific example of the first aspect, the flexible substrate includes a second coupling region coupled to the actuator substrate, and the detection wiring is disposed in a vicinity of the second coupling region. According to the fifth aspect, it is possible to easily detect that the flexible substrate 4 is exposed to a high-humidity environment at an early stage.

In the liquid ejecting head according to a sixth aspect, which is a specific example of the fifth aspect, the flexible substrate includes a first coupling region coupled to the wiring substrate and a wiring region between the first coupling region and the second coupling region, and the wiring region extends in a gravity direction. According to the sixth aspect, it is possible to easily detect that the flexible substrate 4 is exposed to a high-humidity environment at an early stage.

In the liquid ejecting head according to a seventh aspect, which is a specific example of any one of the first to sixth aspects, the flexible substrate includes a first coupling region coupled to the wiring substrate, and a second coupling region coupled to the actuator substrate, and the detection wiring is disposed between one end and another end of the cover film in a direction from the second coupling region to the first coupling region. According to the seventh aspect, it is possible to detect that the flexible substrate 4 is exposed to a high-humidity environment at an early stage.

In the liquid ejecting head according to an eighth aspect, which is a specific example of the seventh aspect, the flexible substrate includes a relay wiring disposed on the mounting surface, one end of the relay wiring is disposed in the first coupling region, another end of the relay wiring is coupled to the detection wiring, and a part of the relay wiring is covered with the cover film. According to the eighth aspect, it is possible to easily detect that the flexible substrate 4 is exposed to a high-humidity environment at an early stage.

The liquid ejecting head according to a ninth aspect, which is a specific example of any one of the first to eighth aspects, further includes a detection circuit that outputs a detection signal for detecting a state of the detection wiring. According to the ninth aspect, it is possible to detect that the liquid is adhered to the detection wiring based on the detection signal output from the detection circuit.

In addition, a liquid ejecting apparatus according to a tenth aspect, which is the preferred aspect, includes the liquid ejecting head according to the ninth aspect, and a determination circuit that determines whether or not a liquid is in a state of being adhered to the detection wiring based on the detection signal. According to the tenth aspect, it is possible to detect that the liquid is adhered to the detection wiring based on the detection signal output from the detection circuit.

The liquid ejecting apparatus according to an eleventh aspect, which is a specific example of the tenth aspect, further includes a notification portion that notifies of an abnormality when the determination circuit determines that the liquid is in a state of being adhered to the detection wiring. According to the eleventh aspect, it is possible to prevent the flexible substrate 4 from failing when the liquid ejecting head 200 is continuously used in a high-humidity environment.

In addition, a liquid ejecting apparatus according to a twelfth aspect, which is the preferred aspect, includes the liquid ejecting head according to any aspect of the first to eighth aspects, a detection circuit that outputs a detection signal for detecting a state of the detection wiring, a determination circuit that determines whether or not a liquid is in a state of being adhered to the detection wiring based on the detection signal, and a notification portion that notifies of an abnormality when the determination circuit determines that the liquid is in a state of being adhered to the detection wiring. According to the twelfth aspect, it is possible to prevent the flexible substrate 4 from failing when the liquid ejecting head 200 is continuously used in a high-humidity environment.

What is claimed is:

1. A liquid ejecting head comprising:
an actuator substrate that includes a plurality of drive elements for ejecting a liquid;
a wiring substrate; and
a flexible substrate that electrically couples the actuator substrate and the wiring substrate, wherein
the flexible substrate includes
a base film that has a mounting surface,
a plurality of wirings disposed on the mounting surface,
an insulating cover film that covers the plurality of wirings so as to interpose the plurality of wirings between the cover film and the mounting surface, and
a detection wiring disposed on the mounting surface at a position not covered with the cover film, and for detecting that the liquid is adhered to the detection wiring.

2. The liquid ejecting head according to claim 1, wherein
the flexible substrate includes a drive component that has a selection circuit selecting whether or not to supply a drive signal to each of the plurality of drive elements, and a first coupling region coupled to the wiring substrate, and
the detection wiring is disposed between the first coupling region and the drive component.

3. The liquid ejecting head according to claim 2, wherein
the flexible substrate includes a second coupling region coupled to the actuator substrate, and a wiring region disposed between the first coupling region and the second coupling region, and
the wiring region extends in a gravity direction.

4. The liquid ejecting head according to claim 2, wherein
the detection wiring is disposed closer to the drive component than is the first coupling region.

5. The liquid ejecting head according to claim 1, wherein
the flexible substrate includes a second coupling region coupled to the actuator substrate, and
the detection wiring is disposed in a vicinity of the second coupling region.

6. The liquid ejecting head according to claim 5, wherein
the flexible substrate includes a first coupling region coupled to the wiring substrate, and a wiring region between the first coupling region and the second coupling region, and
the wiring region extends in a gravity direction.

7. The liquid ejecting head according to claim 1, wherein
the flexible substrate includes a first coupling region coupled to the wiring substrate, and a second coupling region coupled to the actuator substrate, and
the detection wiring is disposed between one end and another end of the cover film in a direction from the second coupling region to the first coupling region.

8. The liquid ejecting head according to claim 7, wherein
the flexible substrate includes a relay wiring disposed on the mounting surface,
one end of the relay wiring is disposed in the first coupling region, another end of the relay wiring is coupled to the detection wiring, and a part of the relay wiring is covered with the cover film.

9. The liquid ejecting head according to claim 1, further comprising:
a detection circuit that outputs a detection signal for detecting a state of the detection wiring.

10. A liquid ejecting apparatus comprising:
the liquid ejecting head according to claim 9; and
a determination circuit that determines whether or not a liquid is in a state of being adhered to the detection wiring based on the detection signal.

11. The liquid ejecting apparatus according to claim 10, further comprising:
a notification portion that notifies of an abnormality when the determination circuit determines that the liquid is in a state of being adhered to the detection wiring.

12. A liquid ejecting apparatus comprising:
the liquid ejecting head according to claim 1;
a detection circuit that outputs a detection signal for detecting a state of the detection wiring;
a determination circuit that determines whether or not a liquid is in a state of being adhered to the detection wiring based on the detection signal; and
a notification portion that notifies of an abnormality when the determination circuit determines that the liquid is in a state of being adhered to the detection wiring.
